(19) United States
(12) Patent Application Publication
(10) Pub. No.: US 2025/0271735 A1
(43) Pub. Date: Aug. 28, 2025

(54) IMAGE CAPTURING APPARATUS THAT IS IMPROVED IN OPERABILITY WHILE REDUCING SIZE OF GRIP

(71) Applicant: CANON KABUSHIKI KAISHA, Tokyo (JP)

(72) Inventors: HAYATO MANO, Tokyo (JP); YUTA NAKAMURA, Kanagawa (JP); KENTA ONO, Tokyo (JP); KOICHI SHIGETA, Kanagawa (JP)

(21) Appl. No.: 19/056,141

(22) Filed: Feb. 18, 2025

(30) Foreign Application Priority Data
Feb. 26, 2024 (JP) 2024-026566

(51) Int. Cl. G03B 17/56; G03B 17/02; G03B 17/55; H04N 23/53

(52) U.S. Cl. CPC G03B 17/563; G03B 17/02; G03B 17/55; H04N 23/531

(57) ABSTRACT

An image capturing apparatus including an image capturing apparatus body and a grip rotatably attached to a side surface of the body. The grip includes a grasping portion for being grasped by a user, a first, a second, and a third operation keys for being operated by the user, a lower grip exterior portion covering the first operation key at least from the body, and an upper grip exterior portion covering the third operation key at least from the body. When the grip is in a position where the first and second operation keys are upward of the grasping portion, the third operation key is upward of a line segment connecting between the first and second operation keys, and at the same time, the upper grip exterior portion is more remote from the body than the lower grip exterior portion.

### BACKGROUND OF THE INVENTION

### Field of the Invention

The present invention relates to an image capturing apparatus.

### Description of the Related Art

Conventionally, image capturing apparatuses, such as a camera and a video camera, include one to which a grip for being grasped by a user is attached. In recent years, there is a demand for size reduction of the grip. On the other hand, to improve the operability and the function of the image capturing apparatus, the grip is required to have a lot of operation keys arranged thereon. Even in a case where the grip is reduced in size and at the same time a lot of operation keys are arranged, there is a demand for ensuring the holdability and operability of the grip.

Japanese Patent No. 6492463 discloses a technique for connecting a grip to an image capturing apparatus body to which a plurality of lenses and a battery can be removably attached, via an arm, and changing the position of the grip with respect to the image capturing apparatus body. According to this technique, even when the center of gravity in an optical axis direction is changed due to a difference in weight between a lens and a battery, or the like, a user can stably perform image capturing regardless of a use form.

However, in the technique disclosed in Japanese Patent No. 6492463, the arm and the operation keys of the grip are arranged between the image capturing apparatus body and a grasping portion, which increases a distance between the image capturing apparatus body and the grasping portion. For this reason, it is difficult to reduce the size of the whole apparatus. Further, there is a problem that a load felt by a user with respect to a direction orthogonal to the optical axis is increased, which reduces the operability.

### SUMMARY OF THE INVENTION

The present invention provides an image capturing apparatus that is improved in the operability while reducing the size of a grip.

The present invention provides an image capturing apparatus including an image capturing apparatus body; and a grip rotatably attached to a side surface of the image capturing apparatus body, wherein the grip includes a grasping portion for being grasped by a user, a first, a second, and a third operation elements for being operated by the user, a first exterior that covers the first operation element at least from the image capturing apparatus body, and a second exterior that covers the third operation element at least from the image capturing apparatus body, wherein out of rotational positions of the grip, when the grip is in a first rotational position in which the first operation element and the second operation element are positioned upward of the grasping portion, the third operation element is positioned between the first operation element and the second operation element at a location upward of a line segment connecting between the first operation element and the second operation element, and at the same time, the second exterior is more remote from the image capturing apparatus body than the first exterior.

According to the present invention, it is possible to improve the operability while reducing the size of the grip.

Further features of the present invention will become apparent from the following description of exemplary embodiments (with reference to the attached drawings).

### BRIEF DESCRIPTION OF THE DRAWINGS

FIG. 1 is a front perspective view of an image capturing apparatus according to a first embodiment.

FIG. 2 is a rear perspective view of the image capturing apparatus.

FIG. 3 is a rear perspective view of an image capturing apparatus body in a state in which a grip has been removed.

FIG. 4 is a front perspective view of the image capturing apparatus body in the state in which the grip has been removed.

FIG. 5 is a side view of the image capturing apparatus body to which the grip has been attached at a standard angle for use.

FIG. 6 is a rear view of the grip.

FIG. 7 is a rear view of the grip grasped by a user's right hand.

FIG. 8 is a cross-sectional view taken along MA1-MA1 in FIG. 5.

FIG. 9 is an enlarged view of a portion where operation keys are arranged.

FIG. 10 is a −X side view of the image capturing apparatus body to which the grip has been attached.

FIG. 11 is a +X side view of the grip.

FIG. 12 is a view of the image capturing apparatus body to which the grip has been attached, as viewed from a −Y side.

FIG. 13 is a front perspective view of an internal structure of the image capturing apparatus body.

FIG. 14 is a rear perspective view of the internal structure of the image capturing apparatus body.

FIG. 15 is a front exploded perspective view of the internal structure of the image capturing apparatus body.

FIG. 16 is a rear exploded perspective view of the internal structure of the image capturing apparatus body.

FIG. 17 is a top view of the internal structure.

FIG. 18A is a rear view, and FIG. 18B is a cross-sectional view, taken along NA-NA in FIG. 18B, of the internal structure.

FIG. 19 is a top view of the image capturing apparatus body.

FIG. 20 is a left side view of the image capturing apparatus body.

FIG. 21 is a left side view of the image capturing apparatus at a time when a user grasps the grip.

FIGS. 22A and 22B are a front perspective view and a rear perspective view of the image capturing apparatus.

FIG. 23 is a front perspective view of the image capturing apparatus, from which illustration of a panel cable is omitted.

FIGS. 24A and 24B are an enlarged perspective view of the image capturing apparatus body and an enlarged perspective view of a panel unit.

FIG. 25 is a schematic view of the panel cable.

FIGS. 26A and 26B are a perspective view of a body-side retainer member and a perspective view of a panel-side retainer member.

FIGS. 27A and 27B are a rear perspective view and a front perspective view of part around a body-side insertion portion.

FIGS. 28A and 28B are an enlarged front view and an enlarged cross-sectional view, taken along OA-OA, of the part around the body-side insertion portion.

FIG. 29 is a front perspective view of the part around the body-side insertion portion at a time when the panel cable is not attached.

FIG. 30 is a front perspective view of an image capturing apparatus according to a second embodiment.

FIG. 31 is a front perspective view of the image capturing apparatus from which part of the component units has been separated.

FIGS. 32A and 32B are perspective views of the panel unit, as viewed from a display section side and a side opposite from the display section, respectively.

FIGS. 33A to 33D are perspective views of the panel unit.

FIG. 34 is a perspective view of a panel cable.

FIG. 35 is a perspective view of a panel cable.

FIGS. 36A to 36C are perspective views each showing a state in which a plug portion has been inserted in a socket portion.

FIGS. 37A to 37C are perspective views of the panel unit, and a view of the panel cable and a retainer member, as viewed from the inside.

FIGS. 38A and 38B are views of a panel unit of an image capturing apparatus according to a third embodiment, as viewed from a display section side and a side opposite from the display section, respectively.

FIG. 39 is a perspective view of a retainer member.

FIG. 40 is an exploded perspective view of part of the panel unit.

FIGS. 41A to 41F are perspective views and cross-sectional views of the panel unit.

FIGS. 42A to 42D are perspective views and a cross-sectional view of the panel unit, and a view of the retainer member and so forth, as viewed from the inside.

FIGS. 43A to 43D are perspective views and a cross-sectional view of the panel unit, and a view of the retainer member and so forth, as viewed from the inside.

### DESCRIPTION OF THE EMBODIMENTS

The present invention will now be described in detail below with reference to the accompanying drawings showing embodiments thereof.

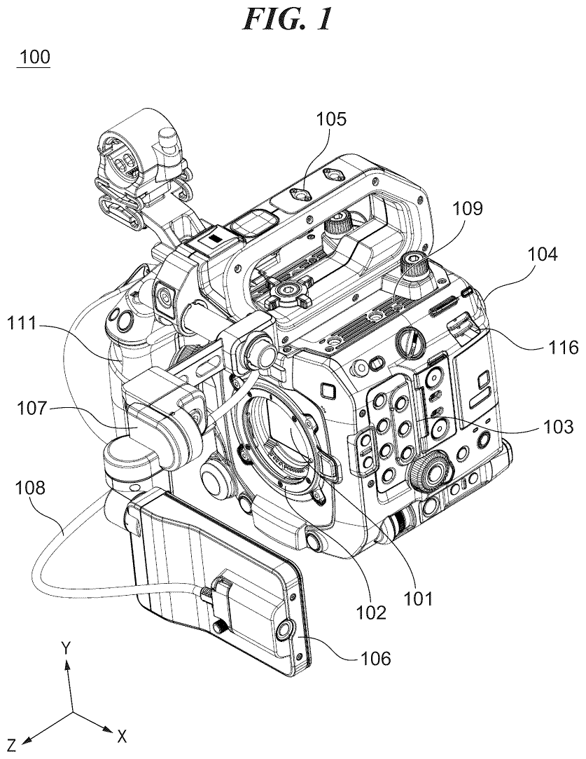

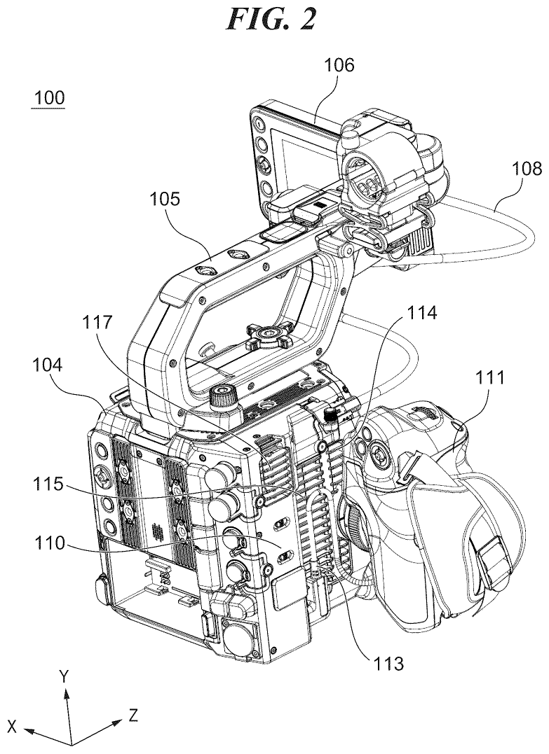

FIGS. 1 and 2 are a front perspective view and a rea perspective view of an image capturing apparatus according to a first embodiment of the present invention.

Hereafter, directions of each component are referred to with reference to X, Y, and Z coordinate axes indicated in each drawing. Here, in a direction parallel to the center of an optical axis, an object side is referred to as the front (+Z direction) for convenience sake. The Z axis is perpendicular to an imaging surface of a sensor 101. The Y axis is an axis representing a vertical direction of the image capturing apparatus, denoted by reference numeral 100, and an upward direction is defined as a +Y direction. The X axis is an axis representing a lateral direction of the image capturing apparatus 100, and a right direction as viewed from the object side is defined as a +X direction.

First, a configuration of the image capturing apparatus 100 will be described with reference to FIGS. 1 and 2.

The image capturing apparatus 100 includes an image capturing apparatus body 104, a handle 105, a panel unit 106, and a grip 111. The image capturing apparatus body 104 has a lens attaching portion 102 and the sensor 101 that generates video data based on an optical image formed thereon, which are arranged on a front part. The lens attaching portion 102 is an attaching portion to which a various types of lenses which are different in optical performance can be removably attached. On a right side surface 103 (+X-side surface) of the image capturing apparatus 100, operation members, such as a variety of buttons, are arranged. A user operates these operation members, whereby the user can perform a variety of operations, such as an operation of switching power on/off of the image capturing apparatus 100, an image capturing operation for recording, and an audio adjustment operation.

On a top surface 109 (+Y-side surface) of the image capturing apparatus body 104, the handle 105 used by a user to hold the image capturing apparatus 100 is provided. Further, the panel unit 106 for confirming an image capturing operation for recording is attached to the handle 105 via a panel unit-disposing mechanism 107. With the panel unit-disposing mechanism 107, it is possible to adjust the panel unit 106 to a desired position and to a desired angle with respect to the handle 105.

The panel unit 106 is connected to the image capturing apparatus body 104 via a panel cable 108. This enables transmission of a video signal, supply of electric power, and transmission and reception of a control signal, from the image capturing apparatus body 104 to the panel unit 106. Details of how to attach the panel cable 108 to the image capturing apparatus body 104 and the panel unit 106 will be described hereinafter.

On a left side surface 110 (−X-side surface) of the image capturing apparatus body 104, the grip 111 for holding the image capturing apparatus 100 is disposed. The grip 111 is attached in a state rotatable about the X axis with respect to the image capturing apparatus body 104. The image capturing apparatus body 104 and the grip 111 are electrically connected to each other via a grip cable 113. This enables supply of electric power, and transmission and reception of a control signal from the image capturing apparatus body 104 to the grip 111. Details of the grip 111 will be described hereinafter.

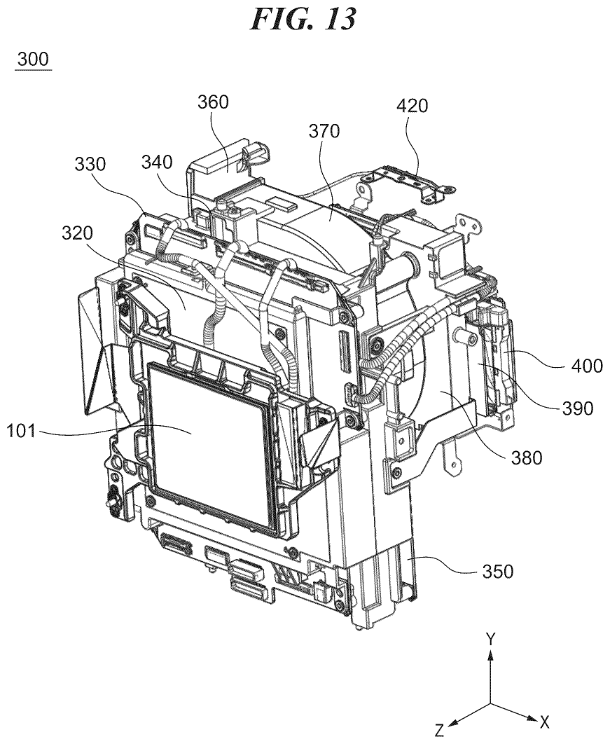

The image capturing apparatus body 104 is equipped with a function of taking in outside air, exhausting heat generated from internal circuit boards to the outside together with exhaust wind, by using an air blower 360 (see FIG. 13) to thereby keep the temperature of the image capturing apparatus body 104 at a temperature equal to or lower than a fixed temperature. To take in air, a first air inlet port 114 and a second air inlet port 115 are arranged in the left side surface 110 (−X-side surface) of the image capturing apparatus body 104, and a third air inlet port 116 is arranged in the right side surface 103. Further, an air exhaust port 117 for exhausting air warmed inside the image capturing apparatus body 104 is disposed in the left side surface 110. Details of a heat dissipation structure will be described hereinafter.

Note that the image capturing apparatus 100 includes, in addition to these, a variety of components necessary to achieve a function for recording a moving image. However, details of these components and the function have less relation with the essence of the present invention, and hence description thereof is omitted.

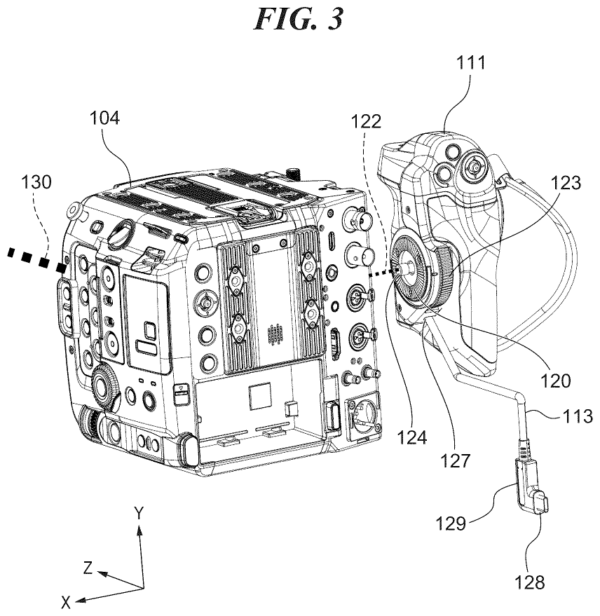

Next, the details of the grip 111 will be described with reference to FIGS. 3 to 11.

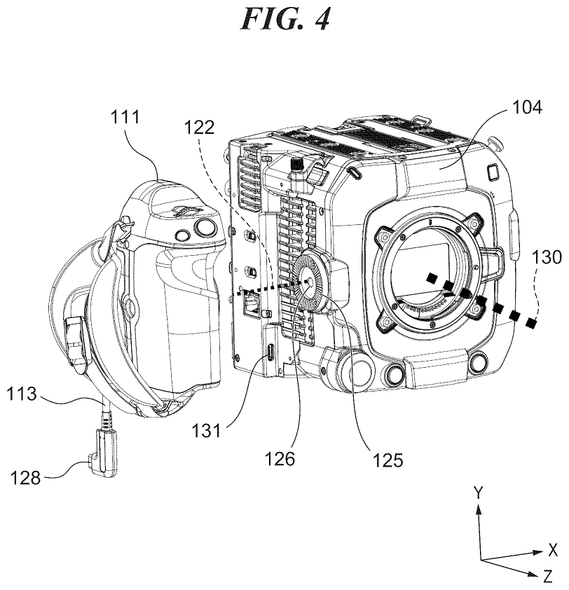

First, how to connect the image capturing apparatus body 104 and the grip 111 will be described with reference to FIGS. 3 and 4.

FIGS. 3 and 4 are a rear perspective view and a front perspective view of the image capturing apparatus body 104 in a state in which the grip 111 has been removed, respectively. The grip 111 has a grip-side attaching portion 120 having rosette-shaped appearance, disposed on a grip rotational axis 122 indicated by a broken line. The grip-side attaching portion 120 has a male screw portion 124 which rotates interlockingly with a rotary operation portion 123. The image capturing apparatus body 104 is provided with a body-side attaching portion 125 having rosette-shaped appearance. The body-side attaching portion 125 has a female screw portion 126 on the grip rotational axis 122.

By aligning the respective centers of the grip-side attaching portion 120 and the body-side attaching portion 125 and rotating the rotary operation section 123, the male screw portion 124 is screwed in the female screw portion 126, whereby the grip 111 is attached to the image capturing apparatus body 104 (state shown in FIG. 2). Note that the user can attach the grip 111 to the image capturing apparatus body 104 at a desired angle, with the grip rotational axis 122 in the center. With this, the user can perform shooting by setting the grip 111 at a preferred angle even when high-angle shooting or low-angle shooting is performed.

An end portion of the grip cable 113, toward the grip 111, is connected to an internal circuit board of the grip 111 and extends from a wire connection position 127, which is positioned at a location on the −Y side of the grip-side attaching portion 120, in a direction between the −Z direction and the −Y direction. An end portion of the grip cable 113, toward the image capturing apparatus body 104, is comprised of a plug 128 and a housing portion 129 which is bent from the plug 128 in a direction substantially orthogonal thereto. A jack 131 which faces in a direction substantially orthogonal to the grip rotational axis 122 indicated by a broken line is provided at a location on the −Y side and the −Z side of the body-side attaching portion 125 of the image capturing apparatus body 104. When the plug 128 is inserted into the jack 131, the image capturing apparatus body 104 and the grip 111 are electrically connected to each other, thereby enabling supply of electric power and transmission and reception of a control signal.

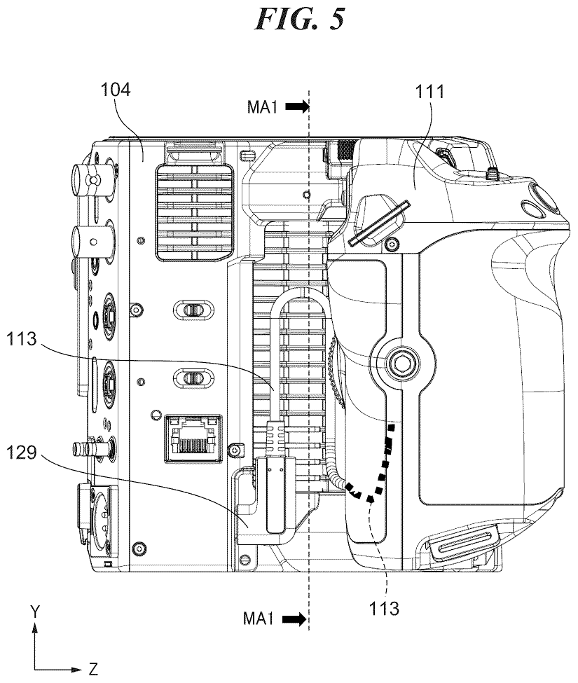

FIG. 5 is a side view of the image capturing apparatus body 104 to which the grip has been attached at a standard angle for use. Part of the grip cable 113, hidden by the grip 111, is expressed by a broken line for convenience of explanation. As shown in FIG. 5, the grip cable 113 has an excess length having an N-shape, and hence even when the grip 111 is rotated with respect to the image capturing apparatus body 104, a level of tension which stretches the grip cable 113 to cause a break thereof is prevented from being applied to the grip cable 113. Further, even if the grip cable 113 is pulled by an irregular motion, since the front end of the grip cable 113 has an L-shape, the plug 128 (see FIG. 3) is difficult to be pulled off from the jack 131. Further, even when the plug 128 is inserted into the jack 131 in a state in which the +Y-side end and the −Y-side end of the plug 128 are reversed, the plug 128 can be mechanically and electrically, for use.

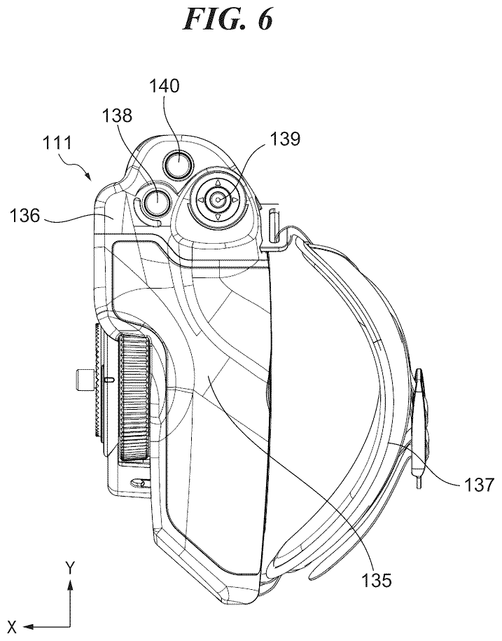

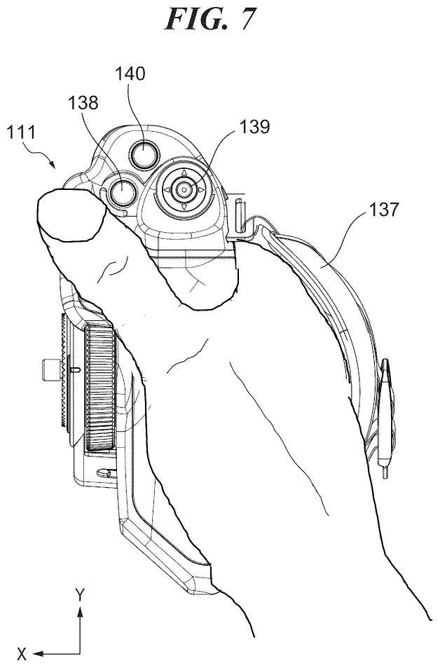

Next, how to grasp the grip 111 and operate the rear-side keys will be described with reference to FIGS. 6 and 7.

FIG. 6 is a rear view of the grip 111. FIG. 7 is a rear view of the grip grasped by a user's right hand.

The grip 111 has a rear grasping portion 135, a thumb placing portion 136, and a hand back-fitting part 137 having upper and lower portions connected to the grip 111. The rear grasping portion 135 is a portion for being grasped by a user. A first operation key 138, a second operation key 139, and a third operation key 140 are arranged at respective locations upward (+Y direction) of the rear grasping portion 135. The operation keys 138, 139, and 140 are respective examples of a first operation element, a second operation element, and a third operation element, which are operated by the user.

In a case where a user grasps the grip 111, the user grasps the rear grasping portion 135 with the base of the thumb, and the back side of the hand is brought into contact with the hand back-fitting part 137. Further, the thumb is brought to a state in which the thumb is placed on the thumb placing portion 136.

In a case where the user operates the first operation key 138, the second operation key 139, and the third operation key 140, the user operates them using the thumb separated from the thumb placing portion 136. Thus, since the operation keys are arranged at the respective locations upward (+Y side) of the rear grasping portion 135, it is possible to make the position where the grip 111 is grasped closer to the image capturing apparatus body 104 than in a case where the operation keys are arranged on the left side (−X side) of the rear grasping portion 135. This makes it possible to reduce a load applied to the user's hand by the weight of the image capturing apparatus 100, which improves the operability.

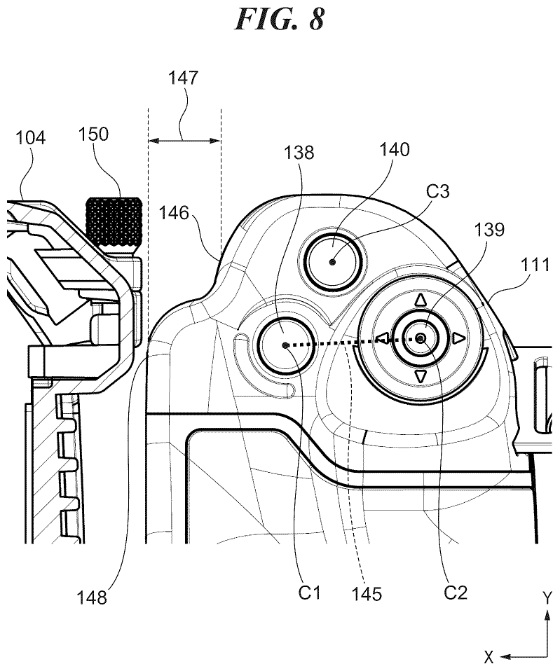

FIG. 8 is a cross-sectional view taken along MAI-MAI in FIG. 5. A positional relationship between the image capturing apparatus body 104 and the grip 111 and a positional relationship between the operation keys 138, 139, and 140 will be described with reference to FIG. 8.

As shown in FIG. 8, out of the rotational positions of the grip 111 with respect to the image capturing apparatus body 104, a rotational position at which the operation keys 138, 139, and 140 are positioned upward of the rear grasping portion 135 is defined as a first rotational position.

A line segment connecting between the center C1 of the first operation key 138 and the center C2 of the second operation key 139 is defined as a line segment 145 indicated by a broken line. The center C3 of the third operation key 140 is positioned upward of the line segment 145 and at the same time between the first operation key 138 and the second operation key 139.

This key arrangement forming a triangle is advantageous for reducing the height of the third operation key 140 in the Y direction while separating the respective operation keys by a certain distance so as to prevent each operation key from being erroneously operated. By reducing the height of the third operation key 140 in the Y direction, the user can easily cause his/her thumb to reach the third operation key 140 even when the user has less freedom of his/her right hand due to the back side-fitting portion 137, which can improve the operability. Further, by reducing the height of the third operation key 140 in the Y direction, it is possible to easily reduce the size of the whole grip 111 in the Y direction.

Further, the grip 111 has an upper grip exterior portion 146 (second exterior) and a lower grip exterior portion 148 (first exterior). The upper grip exterior portion 146 includes part covering the third operation key 140 at least from a side (+X side) of the image capturing apparatus body 104. The lower grip exterior portion 148 includes part covering the first operation key 138 at least from a side (+X side) of the image capturing apparatus body 104.

The image capturing apparatus body 104 is provided with an operation member 150 for operating the image capturing apparatus body 104. The operation member 150 is disposed at a location opposed to the upper grip exterior portion 146 when the grip 111 is in the first rotational position.

With the above-described triangular key arrangement, the upper grip exterior portion 146 is more remote from the image capturing apparatus body 104 than the lower grip exterior portion 148 in the X direction. That is, it is possible to space the upper grip exterior portion 146 from the image capturing apparatus body 104 more than the lower grip exterior portion 148 by a distance 147. Strictly describing, the position of the upper grip exterior portion 146 at the height of the center C3 in the X direction is more remote from the capturing apparatus body 104 than the position of the lower grip exterior portion 148 at the height of the center C1 in the X direction, by the distance 147. With this, the user can operate the operation member 150 positioned at the location opposed to the upper grip exterior portion 146 with a sufficient allowance.

Further, when the grip 111 is in the first rotational position, the operation keys 138, 139, and 140 are positioned upward of the rear grasping portion 135 and do not overlap the rear grasping portion 135 in the X direction. This makes it easy to make the rear grasping portion 135 close to the image capturing apparatus body 104, and hence this configuration is advantageous in reducing the size of the whole image capturing apparatus 100 in the X direction (width direction).

In the present embodiment, the first operation key 138 is a push-type key, the second operation key 139 is a cross key (direction input key), and the third operation key 140 is a push-type key. However, each of the operation keys 138, 139, and 140 can be any of a push-type key, a cross key, a slide key, a dial key, and a toggle key.

Note that although the line segment 145 is substantially parallel to the grip rotational axis 122 (see FIG. 3), this is not limitative, but the line segment 145 can be at any other desired angle.

The operation member 150 is a member (such as a rotation lock member) for preventing the panel cable 108 from being pulled off from the image capturing apparatus body 104 when the panel cable 108 is inserted in the image capturing apparatus body 104. However, from a limited viewpoint of capability of operating the operation member 150 with a sufficient allowance, the operation member 150 can be an operation section having another function.

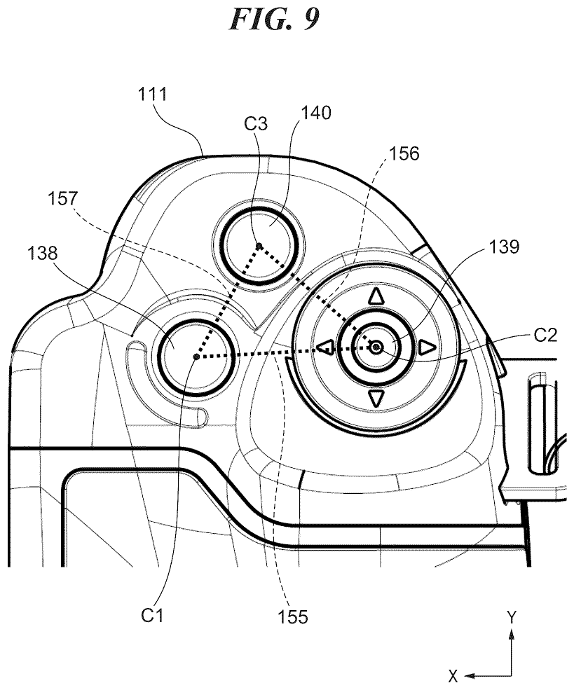

FIG. 9 is an enlarged view of the portion where the operation keys 138, 139, and 140 are arranged. A distance relationship between the first operation key 138, the second operation key 139, and the third operation key 140 will be described with reference to FIG. 9.

A distance between the center C1 of the first operation key 138 and the center C3 of the third operation key 140 (distance between the respective centers) is defined as a distance 157 (indicated by a broken line). A distance between the center C2 of the second operation key 139 and the center C1 of the first operation key 138 is defined as a distance 155 (indicated by a broken line). A distance between the center C2 of the second operation key 139 and the center C3 of the third operation key 140 is defined as a distance 156 (indicated by a broken line).

In general, in a case where a user operates a cross key in vertical and lateral directions, his/her finger largely moves in the vertical and lateral directions, compared with a case where the user operates a push-type key. Therefore, if another operation key is disposed in the vicinity of the cross key, there is large possibility that the user erroneously presses the other operation key.

To prevent this, the magnitude relation between the respective distances is set as the distance 157<the distance 155, and at the same time the distance 157<the distance 156. That is, the distances 155 and 156 between the cross key and the push-type keys are set to be longer than the distance 157 between the pus-type keys. With this, it is possible to prevent an erroneous operation, while reducing the size of the grip 111 by reducing the distances between the operation keys.

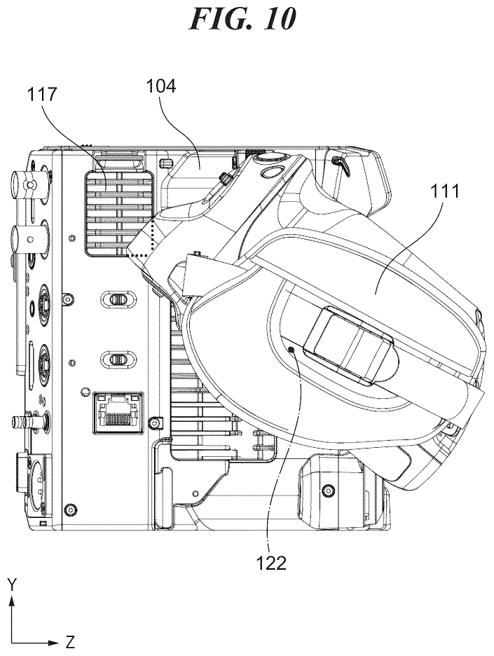

A positional relationship between the grip 111 and the air exhaust port 117 will be described with reference to FIGS. 10 to 12.

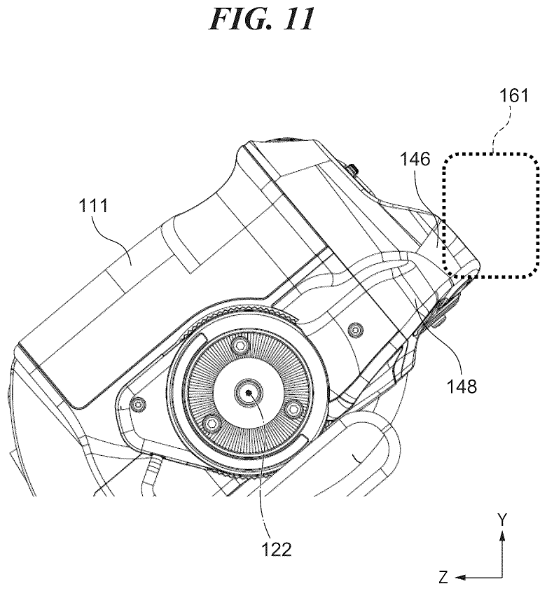

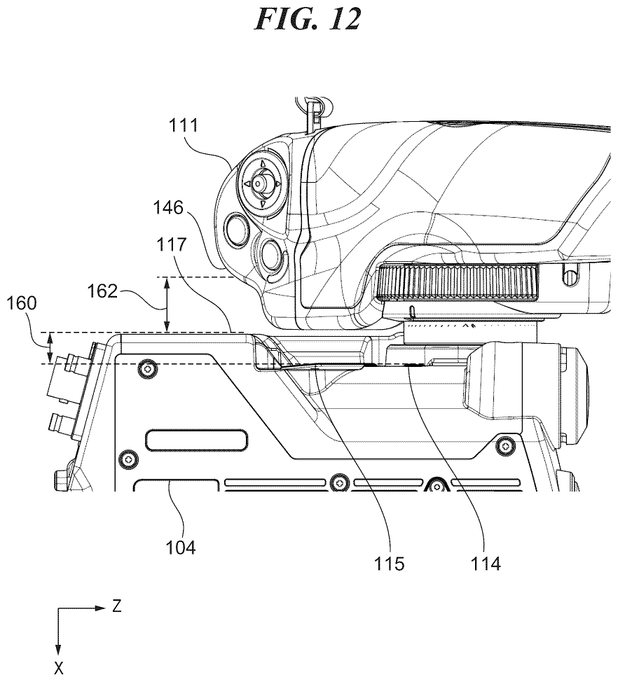

FIG. 10 is a −X-side view of the image capturing apparatus body 104 to which the grip 111 has been attached. FIG. 11 is a +X-side view of the grip 111. FIG. 12 is a view of the image capturing apparatus body 104 to which the grip 111 has been attached, as viewed from the −Y side (bottom view). In FIG. 10, the outline of the air exhaust port 117, hidden by the grip 111, is indicated by a broken line for convenience of explanation. In FIG. 11, a projected shape 161 of the air exhaust port 117 is indicated by a broken line.

Referring to FIGS. 10 to 12, the grip 111 is in a second rotational position, which is different from the first rotational position, with respect to the image capturing apparatus body 104. The second rotational position is a rotational position at which part of the air exhaust port 117 and part of the grip 111 overlap each other as viewed from an axial line direction of the grip rotational axis 122, but the air exhaust port 117 does not overlap the lower grip exterior portion 148. As shown in FIG. 11, the upper grip exterior portion 146 overlaps the projected shadow of the air exhaust port 117, in a state projected in the X direction, but the lower grip exterior portion 148 does not overlap the air exhaust port 117.

As shown in FIG. 12, the air exhaust port 117 of the image capturing apparatus body 104 protrudes toward the grip 111 (−X side) by a distance 160, compared with the first air inlet port 114 and the second air inlet port 115. However, only the upper grip exterior portion 146 of the grip 111 is opposed to the air exhaust port 117, and hence it is possible to separate the air exhaust port 117 and the grip 111 by a distance indicated by an arrow 162 in the X direction, and heat discharge is not interfered with.

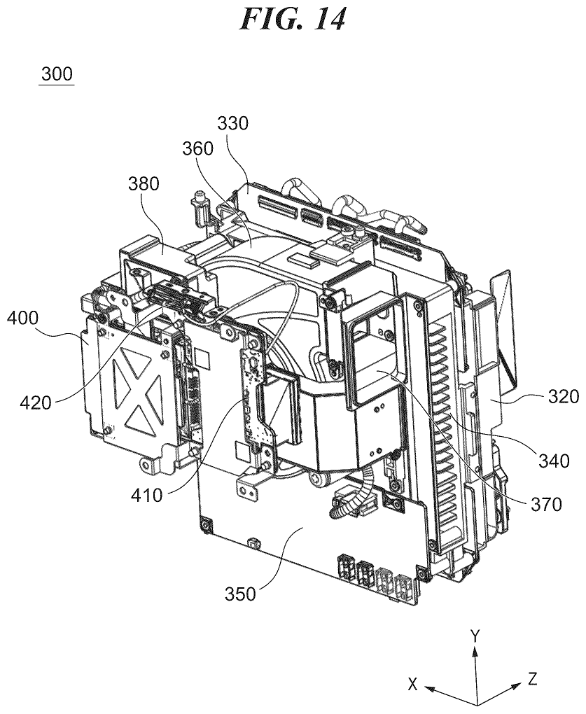

The internal structure of the image capturing apparatus body 104 will be described with reference to FIGS. 13 to 16.

FIGS. 13, 14, 15, and 16 are a front perspective view, a rear perspective view, a front exploded perspective view, and a rear exploded perspective view of the internal structure, denoted by reference numeral 300, of the image capturing apparatus body 104, respectively.

In the internal structure 300 of the image capturing apparatus body 104, the sensor 101, a sensor duct unit 320, a main circuit board 330, a main duct unit 340, and a power supply board 350 are arranged substantially parallel from the front to the rear in the optical axis direction (+Z direction) in the mentioned order. Further, the air blower 360 and an exhaust duct unit 370, a media duct unit 380, a media board 390, a sub media board 400, and a wireless board 410 are arranged substantially parallel toward the rear in the mentioned order. A wireless antenna 420 is disposed in upper part (+Y side) of rear part (−Z side) of the internal structure 300.

The sensor 101 converts light incident through a lens, not shown, to electrical signals. The main circuit board 330 is a board that controls the overall operation of the image capturing apparatus 100 and is the largest in area in the image capturing apparatus 100 in which a lot of integrated circuits (ICs) are mounted. On the main circuit board 330, an IC for processing a signal output from the sensor 101, an IC for performing processing, such as processing for compressing a video, a memory used by these ICs, and so forth, are mounted.

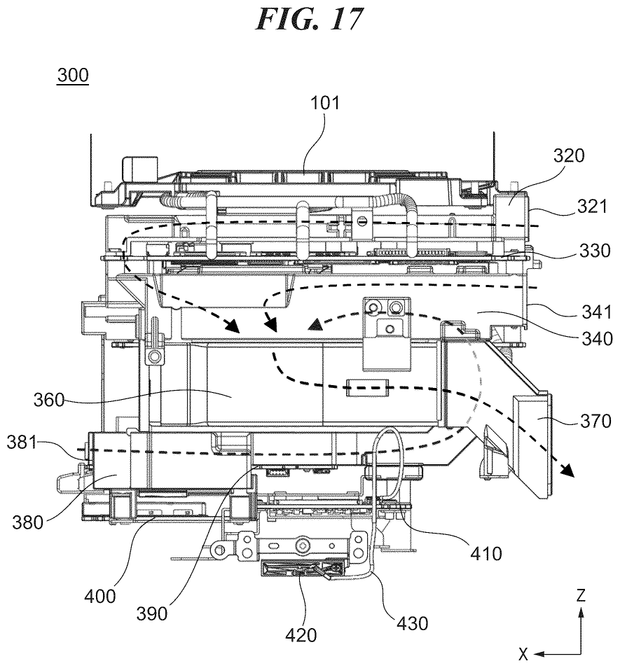

The power supply board 350 supplies electric power to all the electric devices in the image capturing apparatus 100, including the above-mentioned main circuit board 330. The media board 390 is a board for recording a video in a recording medium. The sub media board 400 is a board for storing settings used at the time of shooting, and recording a video for backup, which is reduced in data volume of a video to be recorded by the media board 390. The wireless board 410 is electrically connected to the wireless antenna 420 via a wire 430 (see FIG. 17) to control wireless communication with an external apparatus.

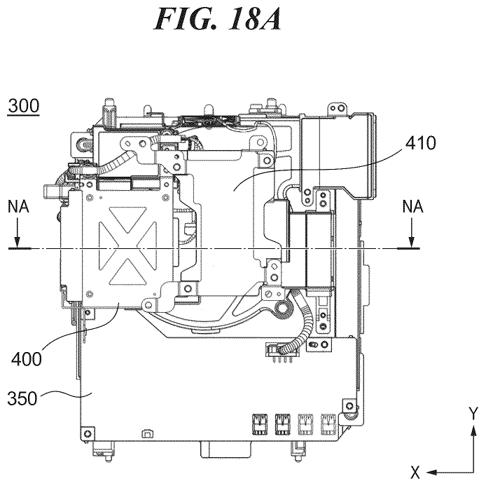

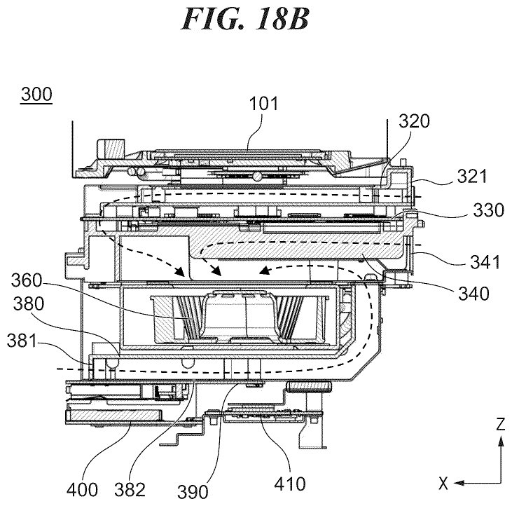

The heat dissipation structure of the image capturing apparatus body 104 will be described with reference to FIGS. 17, 18A, and 18B.

FIG. 17 is a top view of the internal structure 300. FIG. 18A is a rear view of the internal structure 300. FIG. 18B is a cross-sectional view taken along NA-NA in FIG. 18A.

The image capturing apparatus 100 dissipates heat from a variety of heat sources by forced air cooling using the heat dissipation ducts and the air blower 360. The heat dissipation ducts are formed by the above-mentioned sensor duct unit 320, the main duct unit 340, the media duct unit 380, and the exhaust duct unit 370.

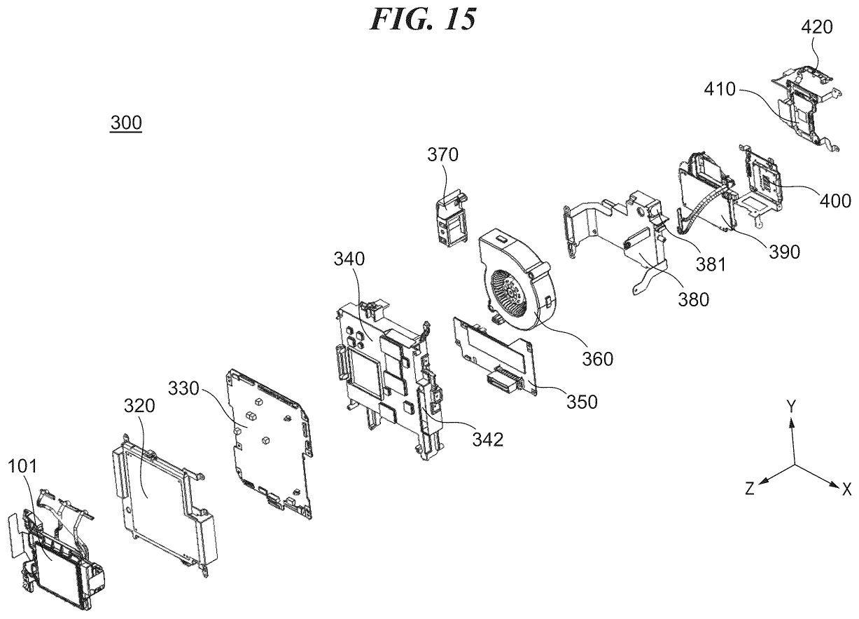

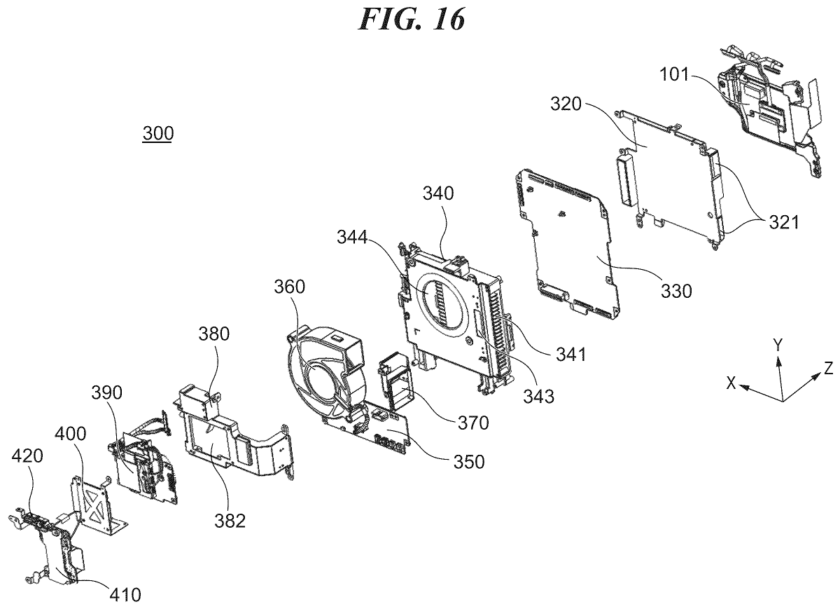

The sensor duct unit 320 takes in outside air from sensor duct air inlet ports 321, and the taken-in air flows from a sensor duct connection portion 342 (see FIG. 15) of the main duct unit 340 into the main duct unit 340. The media duct unit 380 takes in outside air from a media duct air inlet port 381, and the taken-in air flows from a main duct connection portion 343 (see FIG. 16) of the main duct unit 340 into the main duct unit 340. The main duct unit 340 takes in outside air from a main duct air inlet port 341, and the taken-in air flows into a blower connection portion 344 (see FIG. 16).

The air blower 360 takes in air from the blower connection portion 344 of the main duct unit 340. Therefore, the air flowing from the sensor duct unit 320 and the media duct unit 380 into the main duct unit 340 and the air taken in from the main duct air inlet port 341 into the main duct unit 340 merge in the main duct unit 340. Then, the merged air is taken in by the air blower 360 through the blower connection portion 344. The taken-in air is discharged out of the image capturing apparatus 100 through the exhaust duct unit 370.

Here, the sensor duct air inlet ports 321 and the first air inlet port 114 (see FIG. 2) are connected, and the main duct air inlet port 341 and the second air inlet port 115 (see FIG. 2) are connected. Further, the media duct air inlet port 381 and the third air inlet port 116 (see FIG. 1) are connected, and the exhaust duct unit 370 and the air exhaust port 117 (see FIG. 2) are connected. The first air inlet port 114 and the second air inlet port 115, and the sensor duct air inlet ports 321 and the main duct air inlet port 341 (see FIG. 18B) are positioned more toward the object side (+Z side) in the optical axis direction than the air exhaust port 117.

The above-mentioned air flow passage configuration of the forced air cooling in the image capturing apparatus 100 is illustrated by broken lines in FIGS. 17, 18A, and 18B.

Heat generated in the sensor 101 is transferred to the sensor duct unit 320 via a heat-conductive member, such as a graphite sheet, not shown. Heat generated on a +Z-side surface of the main circuit board 330 is transferred to the sensor duct unit 320 via a heat-conductive member, such as heat dissipation rubber, not shown, and heat generated on a −Z-side surface of the main circuit board 330 is transferred to the main duct unit 340 via a heat-conductive member, such as heat dissipation rubber, not shown. Heat generated in the power supply board 350 is transferred to the main duct unit 340 via a heat-conductive member, such as heat dissipation rubber, not shown.

The media board 390 is mounted in an opening 382 (see FIGS. 16 and 18B) of the media duct unit 380, whereby at least part of the media board 390 is exposed in the media duct unit 380. Therefore, air flowing in the media duct unit 380 is in direct contact with the media board 390, and hence a recording medium inserted in the media board 390 is cooled by dissipating heat from the media board 390 itself. By efficiently cooling the recording medium, it is possible to stably perform recording even when power consumption of the recording medium is increased by high-bit rate data e.g. due to high resolution of recent videos.

The sub media board 400 is arranged substantially parallel to the media board 390 at a location rearward (on the-Z side) of the media board 390. The sub media board 400 performs writing of data which is small in data volume, as described above, and hence the amount of generated heat is also small, so that heat dissipation using forced air cooling is not necessarily required.

The wireless board 410 is disposed on substantially the same plane as the sub media board 400, and at the same time, on the-X side of the sub media board 400 (see FIG. 18B). Heat generated in the wireless board 410 is transferred to the media duct unit 380 via a heat-conductive member, not shown. A wireless control IC, not shown, mounted on the wireless board 410 is lower in guaranteed temperature than the other heat sources (the sensor 101, the main circuit board 330, the power supply board 350, and the media board 390) of the internal structure 300. So, by mounting the wireless control IC not on the main circuit board 330, but on the wireless board 410 as an independent board, it is possible to dissipate heat without being affected by the other heat sources having high power consumption.

With the above-described heat dissipation structure of the image capturing apparatus body 104, it is possible to transfer heat of the variety of heat sources of the internal structure 300 to the variety of heat dissipation ducts, which are opposed and adjacent to the heat sources, respectively, exchange the heat to air by the above-described flow passage configuration, and efficiently discharge the heat to the outside of the image capturing apparatus body 104.

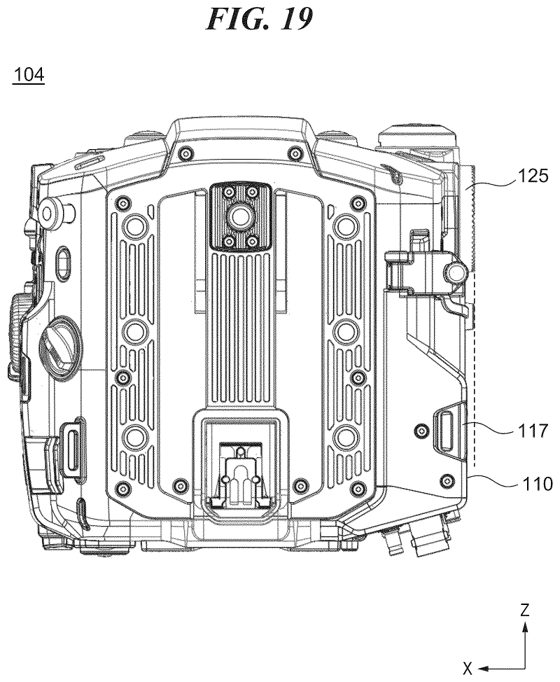

The arrangement of the air exhaust port 117 of the image capturing apparatus body 104 will be described with reference to FIGS. 19 to 21.

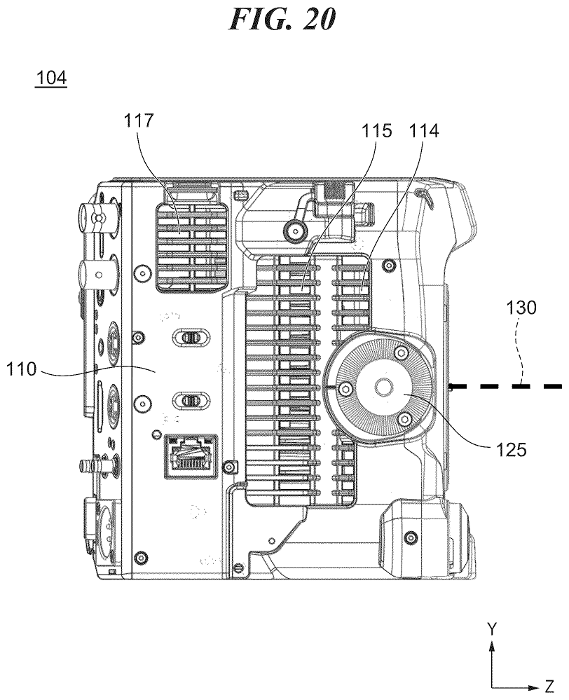

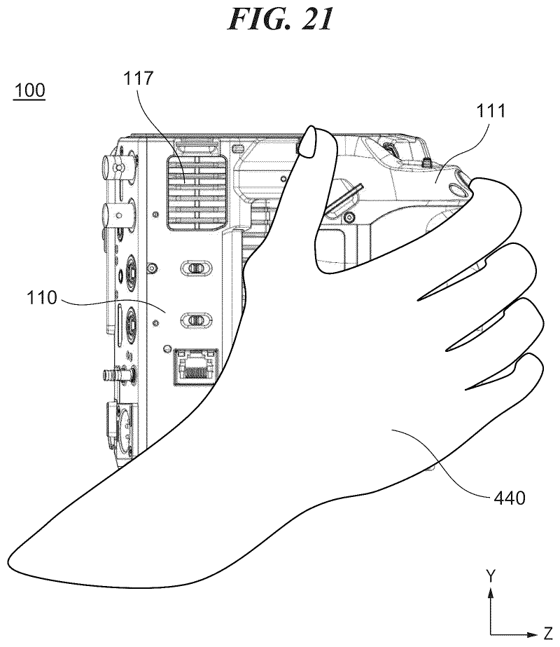

FIGS. 19 and 20 are a top view and a left side view of the image capturing apparatus body 104. FIG. 21 is a left side view of the image capturing apparatus 100 at a time when the user grasps the grip 111.

The air exhaust port 117 is disposed at an end portion of the left side surface 110 on an opposite side (−Z side) thereof to the object side in the optical axis direction, and at the same time at a location upward of the optical axis 130. The air exhaust port 117 opens in a direction substantially perpendicular to the left side surface 110 (toward the −X side).

Similarly, the first air inlet port 114 and the second air inlet port 115 also open toward the-X side substantially perpendicularly to the left side surface 110 and are adjacent to the air exhaust port 117, and hence if no measure is employed, warmed exhaust air wind can be taken in. However, as shown in FIG. 17, wind discharged from the air blower 360 is discharged obliquely rearward by the exhaust duct unit 370. This prevents the first air inlet port 114 and the second air inlet port 115 from taking in the exhaust air.

As indicated by a broken line in FIG. 19, the body-side attaching portion 125 more protrudes outward of the image capturing apparatus body 104 in a direction (X direction) perpendicular to the left side surface 110 than the air exhaust port 117. That is, as viewed from the top surface of the image capturing apparatus body 104, the air exhaust port 117 is accommodated more toward the +X side than the body-side attaching portion 125. This is advantageous in reducing the size of the image capturing apparatus body 104 in the width direction (X direction).

Further, as shown in FIG. 20, the air exhaust port 117 is disposed in

the left side surface 110, at a location opposite from the object in the optical axis direction, and at the same time upward of the body-side attaching portion 125. With this, as shown in FIG. 21, when a photographer grasps the grip 111 during shooting performed by using the image capturing apparatus 100, a hand 440 is prevented from blocking the air exhaust port 117. If the air exhaust port 117 is blocked during shooting, there is a possibility that air cannot be sufficiently discharged, resulting in lowered heat dissipation performance. Further, if the warmed exhaust air is blown to the photographer, uncomfortable feeling is given to the photographer. This situation is prevented.

With this arrangement of the air exhaust port 117, the air exhaust port 117 is not blocked during shooting, and the exhaust wind is not blown to the photographer, and hence it is possible to suppress lowering of the heat dissipation performance and uncomfortable feeling given to the photographer.

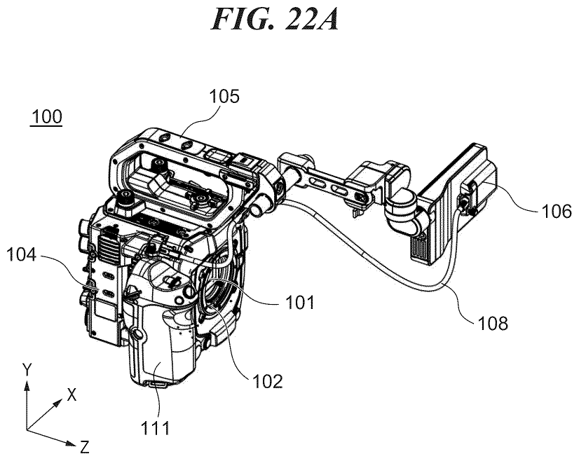

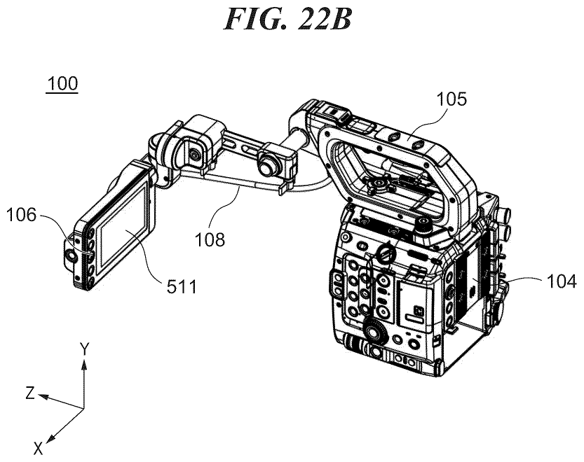

The configuration of the panel unit 106 will be mainly described with reference to FIGS. 22A to 24B.

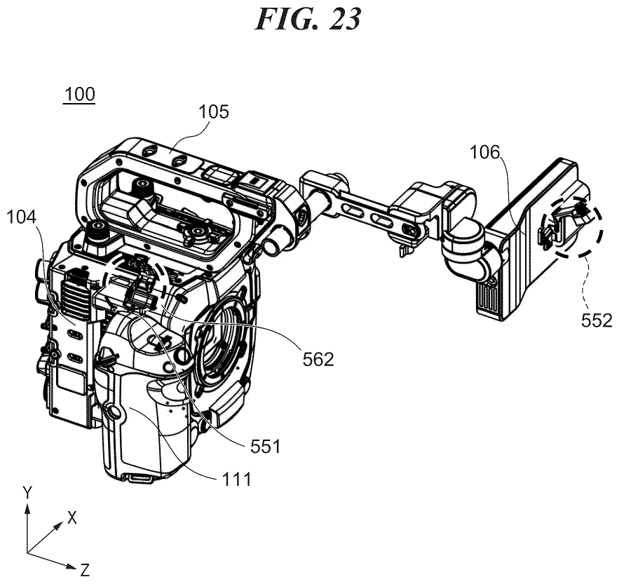

FIGS. 22A and 22B are a front perspective view and a rear perspective view of the image capturing apparatus 100, respectively. FIG. 23 is a front perspective view of the image capturing apparatus 100, from which illustration of the panel cable 108 is omitted. The panel unit 106 is a display device communicably connected to the image capturing apparatus body 104 by the panel cable 108.

The image capturing apparatus 100 is configured to convert light captured by the sensor 101 to signals and send the signals to the display section 511 of the panel unit 106 via the panel cable 108. Note that detailed description of a process for performing this shooting is not related to the present invention, and hence the description thereof is omitted.

First, details of how to attach the panel cable 108 connecting between the image capturing apparatus body 104 and the panel unit 106 will be described.

As shown in FIG. 23, in the image capturing apparatus body 104, a body-side insertion portion 551 in which the panel cable 108 is inserted is disposed in an inclined surface 562 at a location toward the −X side and at the same time on the +Y side of the image capturing apparatus body 104. By arranging the body-side insertion portion 551 on the inclined surface 562 of the image capturing apparatus body 104, it is possible to provide the body-side insertion portion 551 in a space between the image capturing apparatus body 104 and the grip 111, and hence prevent increasing the size of the image capturing apparatus body 104. Further, on the panel unit 106, a panel-side insertion portion 552 in which the panel cable 108 is inserted is disposed on a back surface (rear surface) opposite from the display section 511.

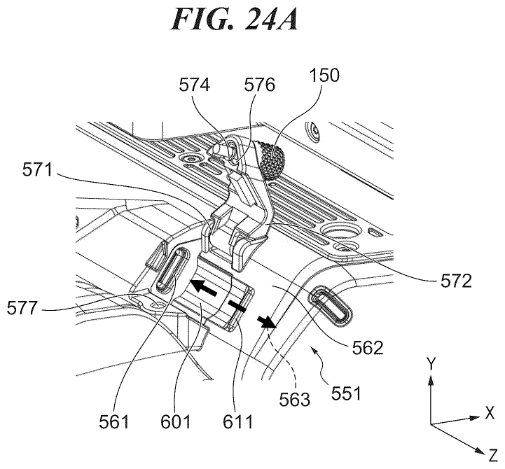

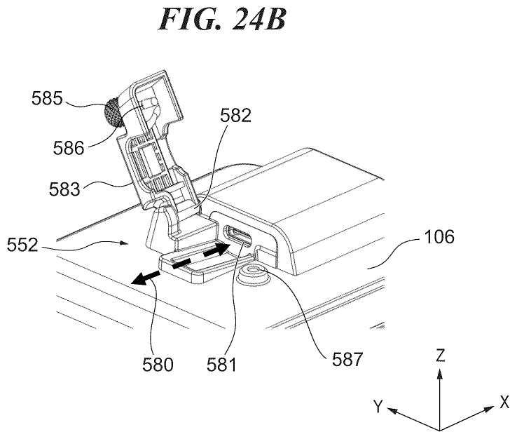

Here, a peripheral structure of the body-side insertion portion 551 and the panel-side insertion portion 552 will be described with reference to FIGS. 24A and 24B. FIG. 24A is an enlarged perspective view of the image capturing apparatus body 104, which illustrates the peripheral structure of the body-side insertion portion 551. FIG. 24B is an enlarged perspective view of the panel unit 106, which illustrates the peripheral structure of t the panel-side insertion portion 552.

First, the body-side insertion portion 551 will be described. As shown in FIG. 24A, on the image capturing apparatus body 104, a body-side socket portion 561 (first socket portion) to which the panel cable 108 is removably inserted is disposed such that its insertion direction is substantially parallel to the inclined surface 562 of the image capturing apparatus body 104. Further, an opening of the body-side socket portion 561 (insertion/removal opening into which the panel cable 108 is removably inserted) opens toward the object side. An insertion/removal direction 563 of the panel cable 108 with respect to the image capturing apparatus body 104 is indicated by a broken-line arrow in FIG. 24A. The panel cable 108 is inserted into the body-side socket portion 561 from the +Z direction to the −Z direction. The insertion/removal direction 563 is substantially parallel to the optical axis.

The image capturing apparatus body 104 has a body-side shaft 571 disposed along the insertion/removal direction 563 and a body-side retainer member 572 supported in a state rotatable about the body-side shaft 571 (about a first axial line) within a predetermined range. The axial line of the body-side shaft 571 is substantially parallel to the insertion/removal direction 563.

The body-side retainer member 572 has a hole 576. The operation member 150 is inserted through the hole 576 and is integrated with the body-side retainer member 572 by a screw retainer member 574.

The image capturing apparatus body 104 has a female screw portion 577 substantially orthogonal to the insertion/removal direction 563. When the operation member 150 is screwed into the female screw portion 577, the body-side retainer member 572 is fixed. Further, the inclined surface 562 is formed with a recess shaped portion 601 for avoiding the outer shape of the panel cable 108 and a rib 611 for receiving static pressure of the panel cable 108. Details of the recess shaped portion 601 and the rib 611 will be described hereinafter.

Here, an outer angular shape of the image capturing apparatus body 104 has a substantially rectangular shape, as viewed from the object side, and the body-side socket portion 561 and the body-side retainer member 572 are arranged in one corner (vertex on the −X side and at the same time on the +Y side) of the rectangular shape.

Next, the panel-side insertion portion 552 will be described. As shown in FIG. 24B, on the panel unit 106, a panel-side socket portion 581 (second socket portion) for removably inserting the panel cable 108 therein is disposed on a surface (rear surface) of the panel unit 106, which is opposite from the display section 511. The panel-side socket portion 581 is disposed substantially parallel to the display surface of the display section 511.

Further, when the panel unit 106 is in a posture shown in FIG. 22A,

an opening of the panel-side socket portion 581 (insertion/removal opening into which the panel cable 108 is removably inserted) opens toward the −X side. An insertion/removal direction 580 of the panel cable 108 into and from the panel unit 106 is indicated by a broken-line arrow in FIG. 24B. When the panel unit 106 is in the posture shown in FIG. 22A, the panel cable 108 is inserted into the panel-side socket portion 581 approximately from the −X direction toward the +X direction.

Further, when the panel unit 106 is in the posture shown in FIG. 22A, the opening direction of the insertion/removal opening can be tilted by 6 degrees in the +Z direction with respect to the display surface of the display section 511. By tilting the insertion/removal opening as described above, the user can easily removably insert the panel cable 108. The insertion/removal direction 580 is substantially parallel to the rear surface of the panel unit 106.

The panel unit 106 has a panel-side shaft 582 and a panel-side retainer member 583. The panel-side shaft 582 is disposed substantially parallel to the display section 511 along the insertion/removal direction 580 of the panel cable 108. The panel-side retainer member 583 is supported in a state rotatable about the panel-side shaft 582 within a predetermined range. The axial line (second axial line) of the panel-side shaft 582 is substantially parallel to the insertion/removal direction 580.

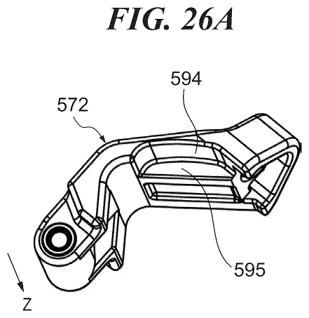

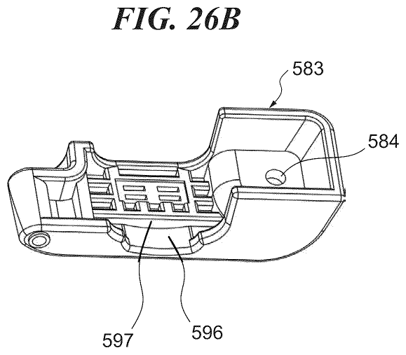

The panel-side retainer member 583 has a hole 584 (see FIG. 26B). A display section-side screw member 585 is inserted through the hole 584 and is integrated with the panel-side retainer member 583 by a screw retainer member 586. The panel unit 106 has a display section-side female screw portion 587 substantially orthogonal to the insertion/removal direction 580. When the display section-side screw member 585 is screwed into the display section-side female screw portion 587, the panel-side retainer member 583 is fixed.

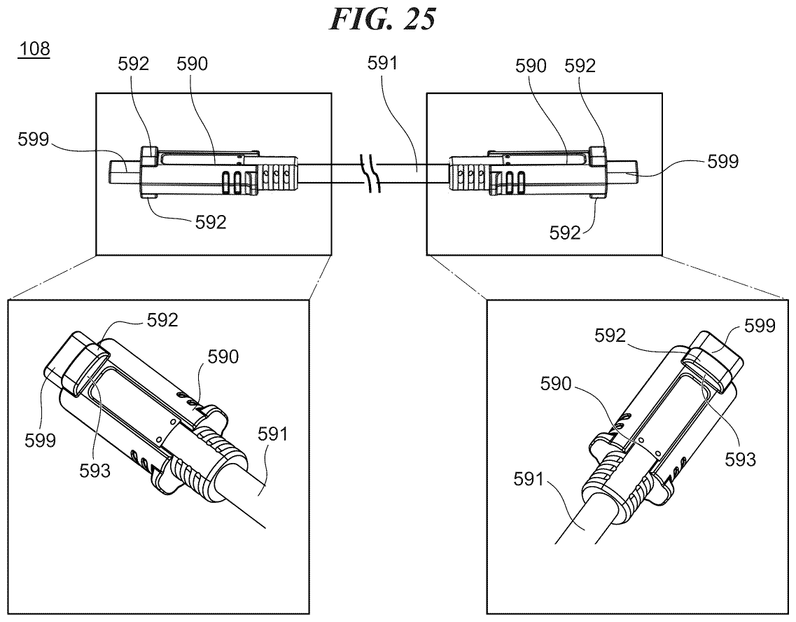

The configuration of the panel cable 108 and a retaining structure of the panel cable 108 will be described with reference to FIG. 25.

FIG. 25 is a schematic view of the panel cable 108. The panel cable 108 includes plug portions 599 which can be inserted and fitted in both the body-side socket portion 561 and the panel-side socket portion 581, respectively.

The panel cable 108 further includes grasping portions 590 each for being held by the user when the panel cable 108 is inserted or removed and a bending portion 591 as a flexible member which is flexibly bent.

Note that the panel cable 108 has the plug portion 599, the grasping portion 590, the bending portion 591, the grasping portion 590, and the plug portion 599, arranged in the mentioned order from one end to the other end thereof. Further, each grasping portion 591 is formed with protruding portions 592. Therefore, the panel cable 108 has the two grasping portions 590 and the bending portion 591 as the flexible member that connects between the two grasping portions 591, and the protruding portions 592 are disposed on opposite ends of the bending portion 591.

The protruding portions 592 are disposed on both of the front and back sides of each grasping portion 590 (both side surfaces of each grasping portion 590 in a direction perpendicular to the insertion/removal direction of each plug portion 599) but can be arranged only on one side. Each protruding portion 592 is provided such that it protrudes in a direction substantially orthogonal to an insertion/removal direction of the plug portion 599. A surface of each protruding portion 592, which is substantially perpendicular to the insertion/removal direction of the panel cable 108 and toward the bending portion 591, is a cable engaging surface 593. The cable engaging surface 593 plays a role of retaining the panel cable 108. The retaining function of the cable engaging surface 593 will be described hereinafter.

FIGS. 26A and 26B are a perspective view of the body-side retainer member 572 and a perspective view of the panel-side retainer member 583. The body-side retainer member 572 is formed with a body-side recess portion 594 and a body-side retainer engaging surface 595 (first engaging portion). The panel-side retainer member 583 is formed with a panel-side recess portion 596 and a panel-side retainer engaging surface 597 (second engaging portion). The body-side recess portion 594 and the panel-side recess portion 596 are avoiding portions for avoiding the protruding portions 592 (see FIG. 25) of the panel cable 108. The body-side retainer engaging surface 595 and the panel-side retainer engaging surface 597 each are opposed to the cable engagement surface 593 (see FIG. 25) of the panel cable 108 to be inserted.

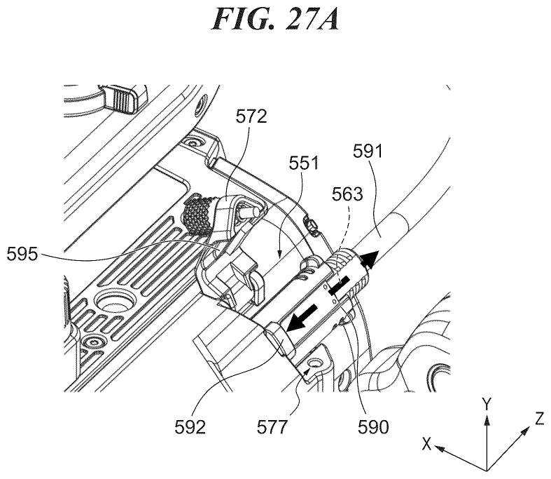

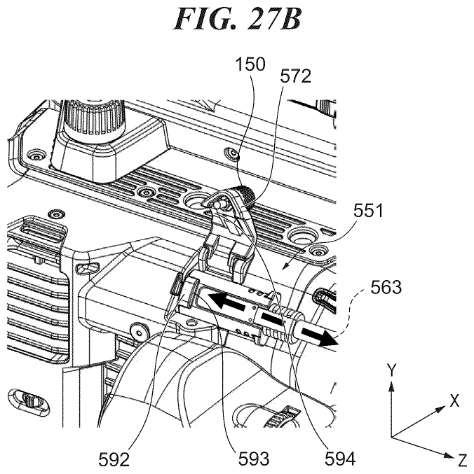

FIGS. 27A and 27B are a rear perspective view and a front erspective view of part around the body-side insertion portion 551 of the image capturing apparatus body 104 to which the panel cable 108 is attached, respectively. A structure for retaining the panel cable 108 by the body-side retainer member 572 will be described.

After the plug portion 599 (see FIG. 25) is fitted in the body-side socket portion 561, when the operation member 150 of the body-side retainer member 572 is screwed into the female screw portion 577, the cable engagement surface 593 of the protruding portion 592 and the body-side retainer engaging surface 595 are opposed in the insertion/removal direction 563 and engaged with each other. With this, the movement of the panel cable 108 along the insertion/removal direction 563 is restricted, whereby it is possible to prevent the panel cable 108 from being carelessly pulled off when the user uses the image capturing apparatus body 104. That is, when the plug portion 599 is inserted into the socket portion, the body-side retainer engaging surface 595 is engaged with the protruding portion 592, whereby the function of retaining the plug portion 599 by the body-side retainer member 572 as the first retainer member is achieved.

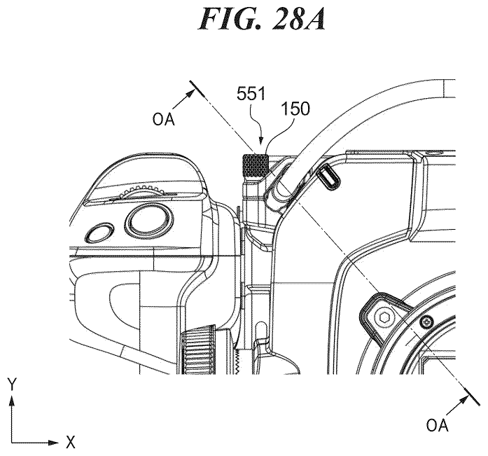

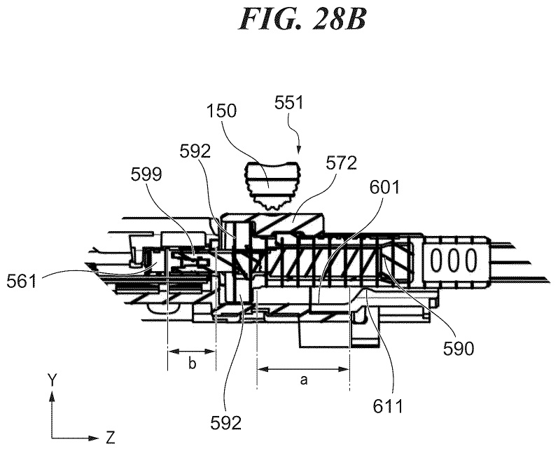

FIG. 28A is an enlarged front view of the part around the body-side insertion portion 551 at a time when the image capturing apparatus body 104 to which the panel unit 106 has been attached is viewed from the object side (+Z direction). FIG. 28B is an enlarged cross-sectional view of the part around the body-side insertion portion 551, taken along OA-OA in FIG. 28A. Note that FIGS. 28A and 28B each show a state in which the panel cable 108 is attached and the operation member 150 is screwed in the female screw portion 577.

The image capturing apparatus body 104 is formed with a recess shaped portion 601 for avoiding the protruding portion 592 when the plug portion 599 is inserted into the body-side socket portion 561. In the direction of insertion/removal of the plug portion 599, a length a of the recess shaped portion 601 is longer than a length b of engagement between the plug portion 599 of the panel cable 108 and the body-side socket portion 561. This prevents insertion and removal of the panel cable 108 from being interfered with.

Further, an end portion of the recess shaped portion 601 is formed with a rib 611 having a protruding shape. The rib 611 is brought into contact with the grasping portion 590 when the plug portion 599 is inserted into the body-side socket portion 561 and urged from the +Y direction toward the-Y direction. With this, the rib 611 supports the panel cable 108, and it is possible to prevent the plug portion 599 and the body-side socket portion 561 from being damaged.

Note that the above description has been given of the structure for retaining the panel cable 108 by using the body-side retainer member 572 in the image capturing apparatus body 104. Although detailed description is omitted, similar to the image capturing apparatus body 104, the panel-side retainer member 583 in the panel unit 106 also realizes the retaining structure by engagement between the cable engagement surface 593 of the protruding portion 592 and the panel-side engagement surface 597 (see FIG. 26B). That is, when the plug portion 599 is inserted into the panel-side socket portion 581 (see FIG. 24B), the panel-side engagement surface 597 is engaged with the protruding portion 592, whereby the function of retaining the plug portion 599 by the panel-side retainer member 583 as the second retainer member is achieved.

Further, although not shown, the panel unit 106 can be formed with a recess shaped portion corresponding to the recess shaped portion 601 for avoiding the protruding portion 592 when the plug portion 599 is inserted into the panel-side socket portion 581. Further, in the direction of insertion and removal of the plug portion 599, a length of the above-mentioned recess shaped portion can be set to be longer than a length of engagement between the plug portion 599 and the panel-side socket portion 581. Further, the panel unit 106 can be formed with a protruding shape portion corresponding to the rib 611, which is brought into contact with the grasping portion 590 when the plug portion 599 is inserted into the panel-side socket portion 581.

Note that the above-described retaining structure can be applied to only one of the image capturing apparatus body 104 and the panel unit 106.

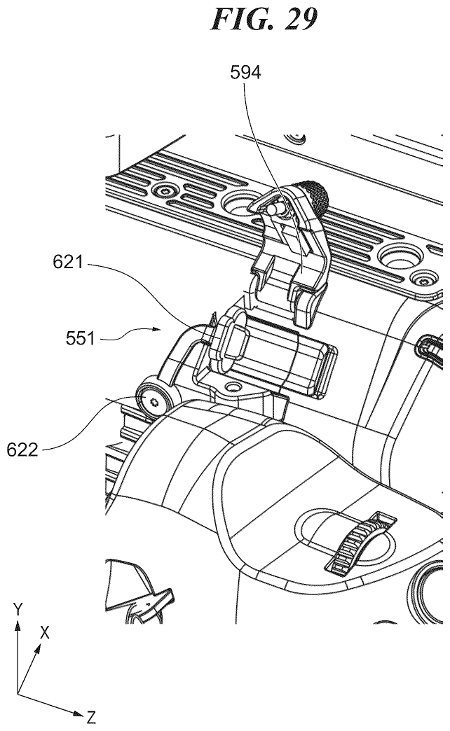

FIG. 29 is a front perspective view of the part around the body-side insertion portion 551 at a time when the panel cable 108 is not attached. A configuration of the image capturing apparatus body 104 at a time when the panel cable 108 is not attached will be described with reference to FIG. 29.

When the panel cable 108 is not attached, the body-side socket portion 561 (see FIG. 24A) can be protected by a protection cover 621 as a cover portion which can be engageable with the body-side socket portion 561. The protection cover 621 is attached to the image capturing apparatus body 104 by a screw 622 and is rotated about the screw 622. The outer shape of the protection cover 621 is a shape for being fitted in the body-side recess portion 594 of the body-side retainer member 572. In the state shown in FIG. 29, when the operation member 150 of the body-side retainer member 572 is screwed into the female screw portion 577, the body-side retainer member 572 plays a role of restricting the movement of the protection cover 621. That is, since the body-side retainer member 572 is fixed to the image capturing apparatus body 104 in the state in which the protection cover 621 is engaged with the body-side socket portion 561, the movement of the protection cover 621 is restricted. Note that this configuration can also be applied to the panel-side insertion portion 552.

According to the present embodiment, with the above-described triangular arrangement of the operation keys 138, 139, and 140 and the arrangement of the upper grip exterior portions 146 and the lower grip exterior portion 148, it is possible to improve the operability while reducing the size of the grip 111.

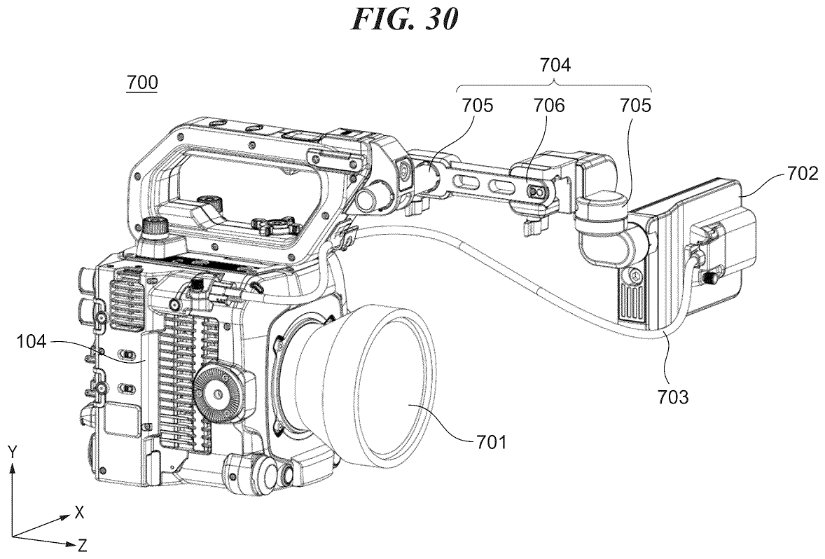

Next, a second embodiment of the present invention will be described. FIG. 30 is a front perspective view of an image capturing apparatus according to the second embodiment. This image capturing apparatus, denoted by reference numeral 700, includes the image capturing apparatus body 104, a lens barrel 701, a panel unit 702, and a panel cable 703. The configuration of the image capturing apparatus body 104 is the same as that of the first embodiment.

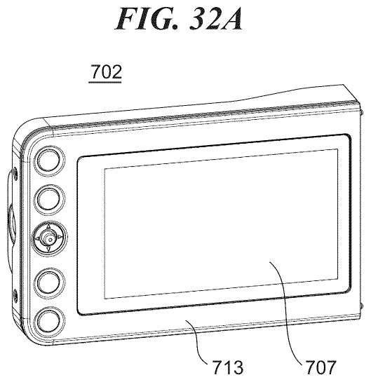

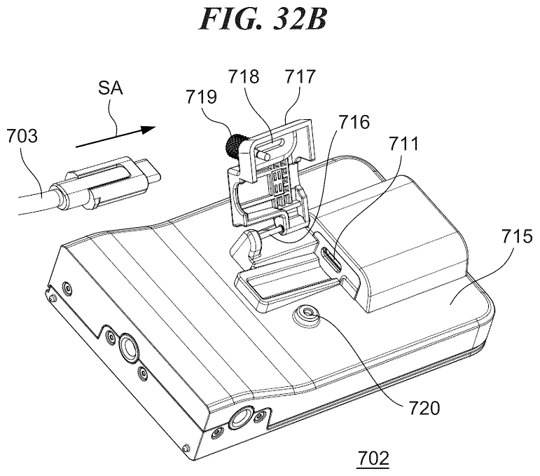

The panel unit 702 can take a desired posture with respect to the image capturing apparatus body 104 according to rotational operations about a plurality of rotational shafts 705 provided in a hinge unit 704 and a sliding operation performed by using a slider 706. The panel unit 702 can receive video signals from the image capturing apparatus body 104 via the panel cable 703 and display a video on a display section 707 (see FIG. 32A), described hereinafter, after processing the video signals by an internal processor (not shown).

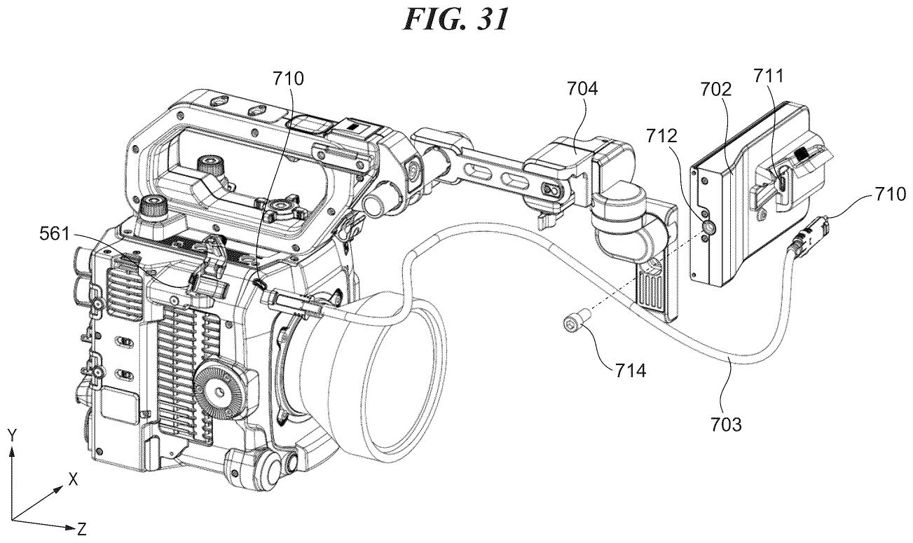

FIG. 31 is a front perspective view of the image capturing apparatus 700 from which part of the component units has been separated. The panel cable 703 can be removably attached to the body-side socket portion 561 of the image capturing apparatus body 104 and a socket portion 711 of the panel unit 702, respectively. That is, a plug portion 710 of the panel cable 703 is held in a state insertable into and removable from the body-side socket portion 561 by a known configuration. Similarly, the plug portion 710 is held in a state insertable into and removable from the socket portion 711 by a known configuration. This enables the image capturing apparatus body 104 and the panel unit 702 to communicate with each other.

In the present embodiment, the plug portion 710 and the socket portion 711 conform to the USB Type-C standard. The panel unit 702 has a female screw portion 712 and can be removably attached to the hinge unit 704 by a male screw member 714.

FIGS. 32A and 32B are perspective views of the panel unit 702, as viewed from the side of the display section 707 and a side opposite from the display section 707, respectively. In FIG. 32B, part of the panel cable 703 is additionally illustrated together with the panel unit 702 for convenience of explanation.

The panel unit 702 has a substantially rectangular parallelepiped shape and has a main surface 713 on which the display section 707 is provided. The socket portion 711 is exposed from a surface 715 (rear surface) opposite from the main surface 713. The panel unit 702 has a shaft 716 and a retainer member 717. The shaft 716 is disposed along (substantially parallel to) an insertion/removal direction SA of the panel cable 703. The retainer member 717 is supported in a state slidable along the shaft 716 within a predetermined range and at the same time rotatable about the shaft 716 within a predetermined range. The retainer member 717 has a slit hole 718 formed along the insertion/removal direction SA. A screw member 719 is inserted through the slit hole 718. The retainer member 717 is slidable along the insertion/removal direction SA.

The panel unit 702 has a female screw portion 720 arranged to be substantially orthogonal to the insertion/removal direction SA. By screwing the screw member 719 as a fixing member into the female screw portion 720, the retainer member 717 can be fixed to a desired position along the shaft 716 within a predetermined range. In the present embodiment, a state in which the retainer member 717 is fixed is referred to as the “closed state”, and an opened state in which the retainer member 717 does not overlap the socket portion 711 as viewed from the axial direction of the shaft 716 is referred to as the “retreated state”.

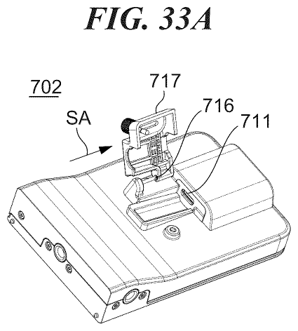

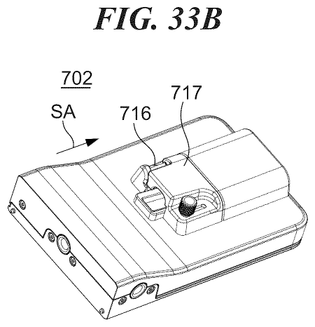

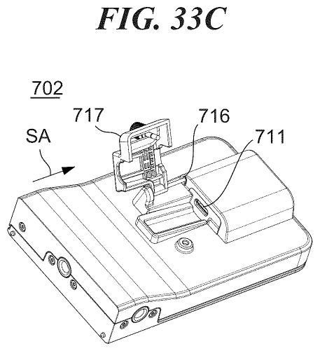

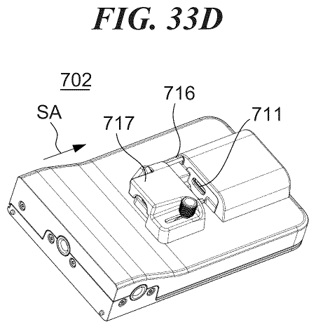

FIGS. 33A and 33C are perspective views of the panel unit 702 in a state in which the retainer member 717 is in the retreated state. FIGS. 33B and 33D are perspective views of the panel unit 702 in a state in which the retainer member 717 is in the closed state. FIGS. 33A and 33B each show a state in which the retainer member 717 is made close to the socket portion 711 along the shaft 716, and FIGS. 33C and 33D each show a state in which the retainer member 717 is made remote from the socket portion 711 along the shaft 716.

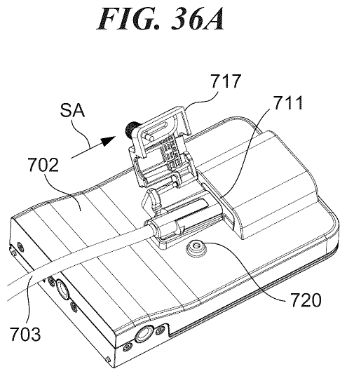

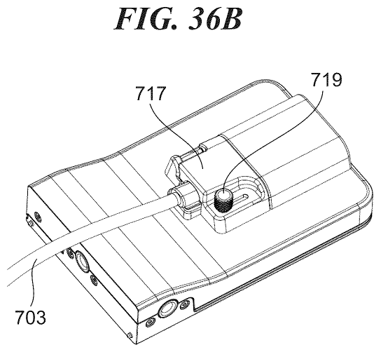

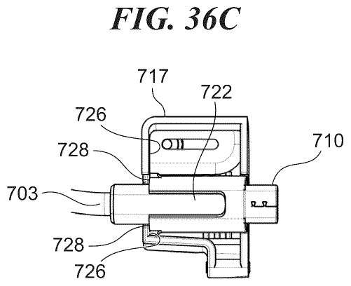

A position in which the retainer member 717 is in the closed state is referred to as the first position (see e.g. FIG. 33B), and a position in which the retainer member 717 is in the retreated state is referred to as the third position (see e.g. FIG. 33A). As for the sliding position in the insertion/removal direction SA, the retainer member 717 is slidable between the first position close to the socket portion 711 and a second position (see e.g. FIG. 33D) remote from the socket portion 711. A position where a cable engagement surface 726 (FIG. 36C) retreats from between the first position and the second position by rotating the retainer member 717 about the axial center of the shaft 716 is the third position. When the retainer member 717 is rotated to the third position, the plug portion 710 can be inserted into and removed from the socket portion 711.

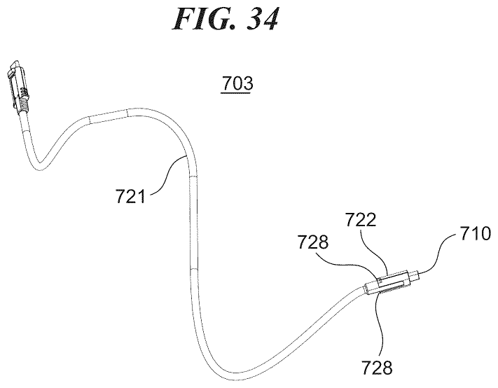

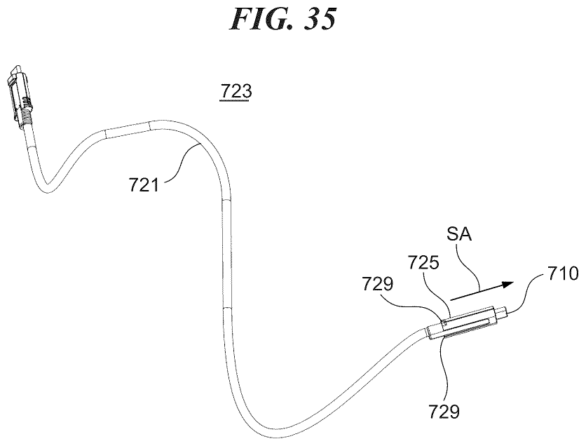

Next, a plurality of panel cables will be described with reference to FIGS. 34 and 35. In the image capturing apparatus 700 according to the present embodiment, the panel cable 703 and a panel cable 723, which are different in the shape of the grasping portion from each other, can be selectively used.

FIG. 34 is a perspective view of the panel cable 703. The panel cable 703 has a bending portion 721 as a flexible member which is flexibly bent, the plug portion 710, and a grasping portion 722 (cable grasping portion). The grasping portion 722 is formed with a retainer member contact surface 728.

FIG. 35 is a perspective view of the panel cable 723. The panel cable 723 has the bending portion 721 as a flexible member which is flexibly bent, the plug portion 710, and a grasping portion 725. The grasping portion 725 is formed with a retainer member contact surface 729. The panel cable 703 and the panel cable 723 are different in the length of the grasping portion 722 and the length of the grasping portion 725 in the plug insertion/removal direction SA.

FIGS. 36A and 36B are perspective views each showing a state in which the plug portion 710 (see FIG. 34) of the panel cable 703 is inserted in the socket portion 711 of the panel unit 702. In FIGS. 36A and 36B, the retainer member 717 is in the position close to the socket portion 711 along the insertion/removal direction SA (the same position as shown in FIGS. 33A and 33B). That is, FIGS. 36A and 36B show the retainer member 717 in the retreated state and the closed state, respectively.

FIG. 36C is a view of the panel cable 703 and the retainer member 717 at a time when the retainer member 717 is in the closed state, as viewed from the inside of the retainer member 717. The retainer member 717 has the cable engagement surface 726 as an engagement portion orthogonal to the insertion/removal direction SA. As shown in FIG. 36C, the cable engagement surface 726 of the retainer member 717 in the closed state is in contact with the retainer member contact surface 728 of the grasping portion 722 of the panel cable 703 to prevent the plug portion 710 from being pulled off from the socket portion 711.

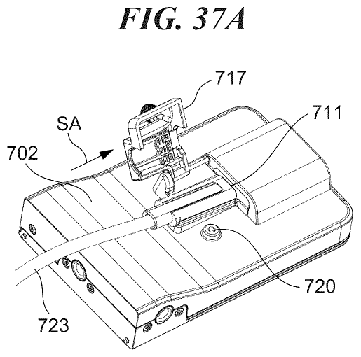

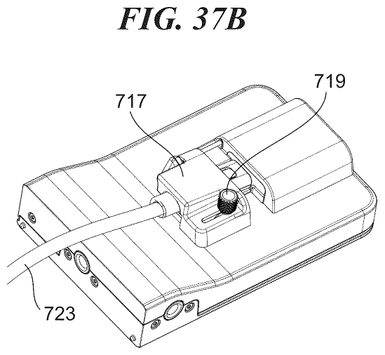

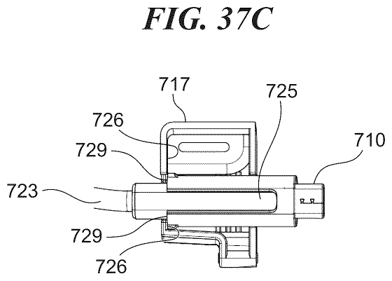

FIGS. 37A and 37B are perspective views each showing a state in which the plug portion 710 (see FIG. 35) of the panel cable 723 is inserted in the socket portion 711 of the panel unit 702. In FIGS. 37A and 37B, the retainer member 717 is in the position remote from the socket portion 711 along the insertion/removal direction SA (the same position as shown in FIGS. 33C and 33D). That is, FIGS. 37A and 37B show the retainer member 717 in the retreated state and the closed state, respectively.

FIG. 37C is a view of the panel cable 723 and the retainer member 717 at a time when the retainer member 717 is in the closed state, as viewed from the inside of the retainer member 717. As shown in FIG. 37C, the cable engagement surface 726 of the retainer member 717 in the closed state is in contact with the retainer member contact surface 729 of the grasping portion 725 of the panel cable 723 to prevent the plug portion 710 from being pulled off from the socket portion 711.

Thus, when the plug portion 710 is inserted in the socket portion 711, the cable engagement surface 726 is engaged with the grasping portion (722 or 725) in the first position or the second position, whereby the function of retaining the plug portion 710 by the retainer member 717 is achieved.

Further, when the screw member 719 and the female screw portion 720 are screwed with each other, the retainer member 717 is fixed to the body of the panel unit 702. At this time, the screw member 719 urges part of the retainer member 717 toward the body of the panel unit 702. With this, the sliding movement of the retainer member 717 is restricted.

According to the present embodiment, it is possible to obtain the same advantageous effects as provided by the first embodiment with respect to improvement of the operability while reducing the size of the grip 111.

Further, the retainer member 717 can take the first position and the second position. Therefore, even when the panel cables (703 and 723) which are different in the length of the grasping portion (722 and 725) are selectively used, it is possible to prevent the plug portion of the panel cable from being pulled off from the socket portion 711.

Next, a third embodiment of the present invention will be described. The third embodiment differs from the second embodiment in the structure for retaining the panel cable and is the same as the second embodiment in the other components.

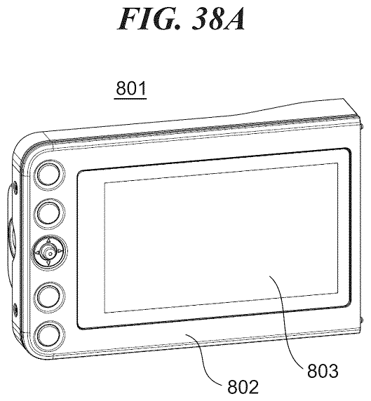

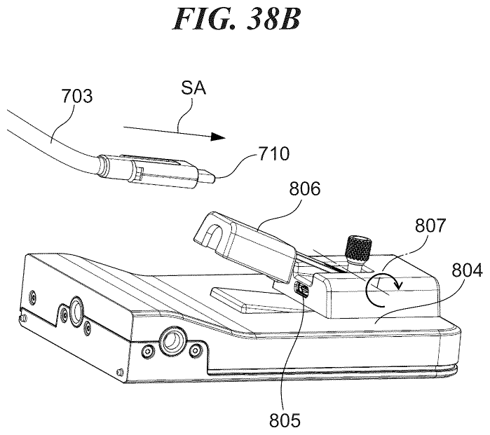

FIGS. 38A and 38B are views of a panel unit 801 of an image capturing apparatus according to the third embodiment, as viewed from a side of a display section 803 and a side opposite from the display section 803, respectively. In FIG. 38B, part of the panel cable 703 is additionally illustrated together with the panel unit 801 for convenience of explanation.

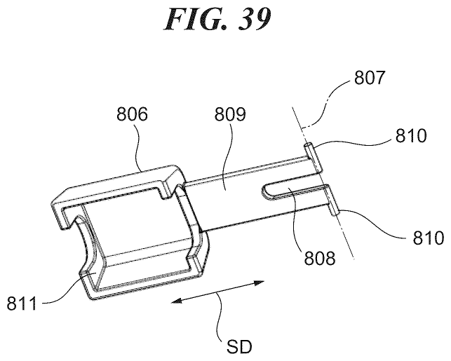

The panel unit 801 has a substantially rectangular parallelepiped shape and has a main surface 802 on which the display section 803 is provided. A socket portion 805 is exposed from a surface 804 (rear surface) opposite from the main surface 802. The panel unit 801 has a retainer member 806. The retainer member 806 is slidable along the insertion/removal direction SA of the panel cable 703 within a predetermined range. Further, the retainer member 806 is rotatable about an axial center 807 substantially orthogonal to the insertion/removal direction SA (slide direction) within a predetermined range. An axial line of stoppers 810, described hereinafter, is the axial center 807 (see FIG. 39).

FIG. 39 is a perspective view of the retainer member 806. The retainer member 806 has a slide portion 809, the stoppers 810, and a cable engagement surface 811. The slide portion 809 has a slit 808. The axial center 807 of the stoppers 810 is orthogonal to a longitudinal direction SD of the slit 808. The cable engagement surface 811 as the engagement portion is provided on an end of the retainer member 806, which is opposite from the stoppers 810, such that it is substantially orthogonal to the longitudinal direction SD of the slit 808.

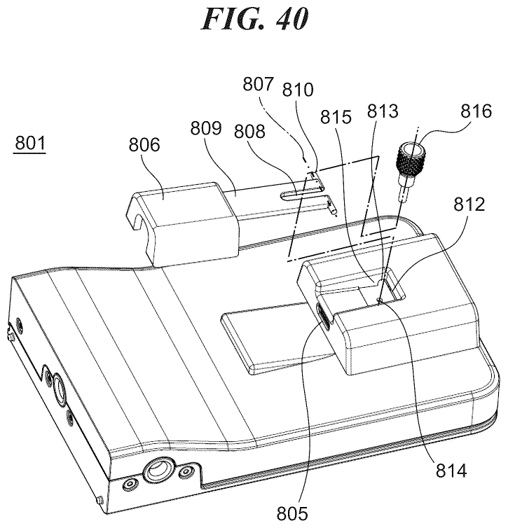

FIG. 40 is an exploded perspective view of part of the panel unit 801. The panel unit 801 has an accommodating portion 812 for accommodating the slide portion 809, a slit 813 in which the stoppers 810 can slide, and a female screw portion 814.

As described hereinafter, the retainer member 806 can be pulled out up to a position where the stoppers 810 are brought into abutment with an end 815 of the slit 813. In the position where the stoppers 810 are in contact with the end 815 of the slit 813, the retainer member 806 is rotatable about the axial center 807 of the stoppers 810. A screw member 816 as a fixing member is inserted through the slit 808 and screwed into the female screw portion 814.

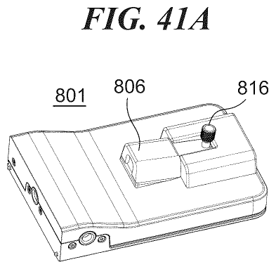

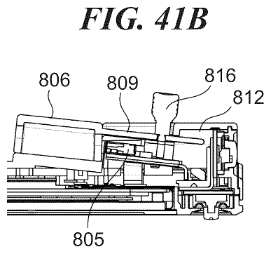

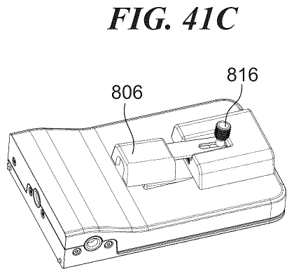

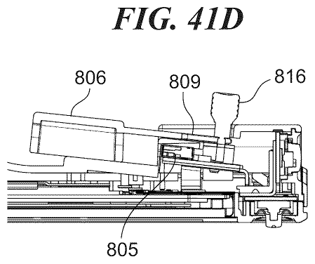

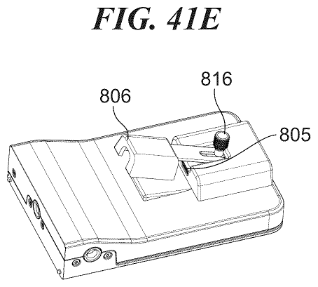

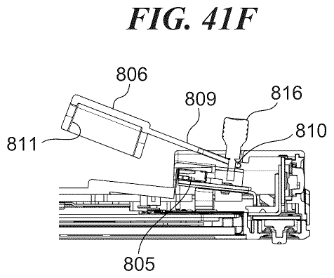

FIGS. 41A, 41C, and 41E are perspective views of the panel unit 801. FIGS. 41B, 41D, and 41F are cross-sectional views each taken along a plane vertically extending through the screw member 816, which passes the socket portion 805 and the screw member 816.

The retainer member 806 can take a first position shown in FIGS. 41A and 41B, a second position shown in FIGS. 41C and 41D, and a third position shown in FIGS. 41E and 41F.

When the retainer member 806 is in the first position (FIGS. 41A and 41B), the slide portion 809 is in a state disposed in the accommodating portion 812. In the first position, by screwing the screw member 816 into the female screw portion (see FIG. 40), the retainer member 806 can be fixed. The retainer member 806 urges the slide portion 809 toward the body of the panel unit 801.

When the retainer member 806 is in the second position (FIGS. 41C and 41D), the retainer member 806 is in a state pulled out to the position where the stoppers 810 are brought into abutment with the end 815 of the slit 813. In the second position, it is also possible to fix the retainer member 806 by the screw member 816, and the retainer member 806 urges the slide portion 809 toward the body of the panel unit 801.

That is, when the retainer member 806 is in the first position or the second position, the retainer member 806 is fixed to the body of the panel unit 801 by screwing between the screw member 816 and the female screw portion 814. At this time, the screw member 816 urges part of the retainer member 806 toward the body of the panel unit 801. With this, the sliding movement of the retainer member 806 is restricted.

The third position (FIGS. 41E and 41F) shows a state in which the retainer member 806 is rotated about the stoppers 810 from the second position.

When the retainer member 806 is in the third position, by loosening the screw member 816, it is possible to release the slide portion 809 from the urged state and rotate the retainer member 806 to the second position.

As for the sliding position in the insertion/removal direction SA, the retainer member 806 can slide between the first position close to the socket portion 805 and the second position remote from the socket portion 805. A position where the retainer member 806 is rotated about the axial center 807, thereby causing the cable engagement surface 811 (see FIG. 40) to retreat from between the first position and the second position, is the third position. When the retainer member 806 is rotated to the third position, the plug portion 710 can be inserted into and removed from the socket portion 805.

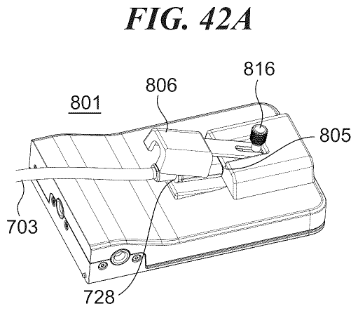

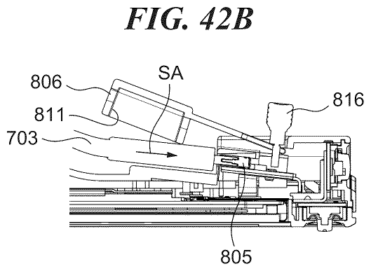

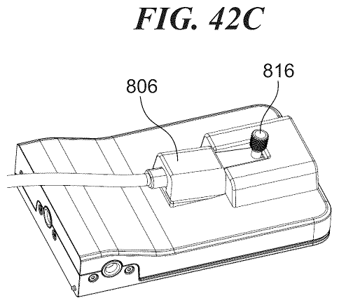

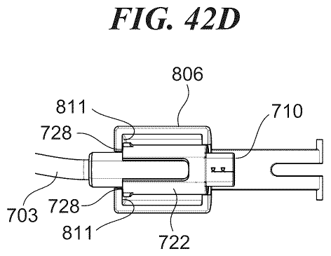

FIGS. 42A and 42C are perspective views of the panel unit 801 in a state in which the plug portion 710 of the panel cable 703 has been inserted in the socket portion 805 of the panel unit 801. FIGS. 42B and 42D correspond to FIGS. 42A and 42C, and are a cross-sectional view taken along a plane vertically extending through the screw member 816, which passes the socket portion 805 and the screw member 816, and a view of the retainer member 806 and the like as viewed from the inside of the retainer member 806, respectively.

In FIGS. 42A and 42B, similar to FIG. 41E, the retainer member 806 is in the third position. In this position, the cable engagement surface 811 of the retainer member 806 and the retainer member contact surface 728 of the grasping portion 722 are not brought into contact with each other, and hence it is possible to freely insert and remove the plug portion 710 of the panel cable 703.

In FIGS. 42C and 42D, similar to FIG. 41A, the retainer member 806 is in the first position. In this position, the cable engagement surface 811 and the retainer member contact surface 728 are brought into contact with each other, and hence the plug portion 710 is prevented from being pulled off from the socket portion 805.

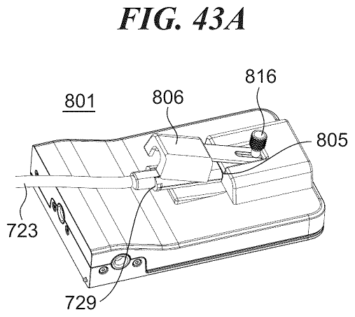

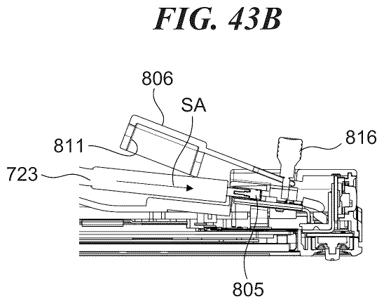

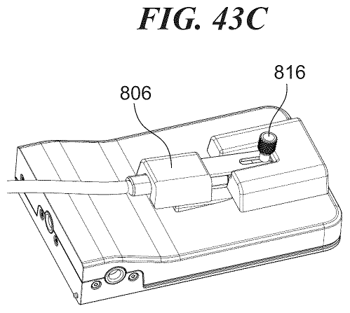

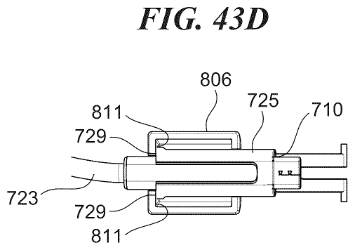

FIGS. 43A and 43C are perspective views of the panel unit 801 in a state in which the plug portion 710 of the panel cable 723 is inserted in the socket portion 805 of the panel unit 801. FIGS. 43B and 43D correspond to FIGS. 43A and 43C, and are a cross-sectional view taken along a plane vertically extending through the screw member 816, which passes the socket portion 805 and the screw member 816, and a view of the retainer member 806 and the like, as viewed from the inside of the retainer member 806, respectively.

As described above, the panel cable 723 is different in the length of the grasping portion from the panel cable 703. Therefore, after the plug portion 710 is inserted, the retainer member 806 is set to the second position.

First, in FIGS. 43A and 43B, similar to FIG. 41E, the retainer member 806 is in the third position. In this position, the cable engagement surface 811 of the retainer member 806 and the retainer member contact surface 729 of the grasping portion 723 are not brought into contact with each other, and hence it is possible to freely insert and remove the plug portion 710 of the panel cable 723.

In FIGS. 43C and 43D, similar to FIG. 41C, the retainer member 806 is in the second position. In this position, the cable engagement surface 811 and the retainer member contact surface 729 are in contact with each other, and hence the plug portion 710 is prevented from being pulled off from the socket portion 805.

Thus, when the plug portion 710 is inserted into the socket portion 805, the cable engagement surface 811 is engaged with the grasping portion (722 or 725) in the first position or the second position, whereby the function of retaining the plug portion 710 by the retainer member 806 is achieved.

According to the present embodiment, it is possible to obtain the

same advantageous effects as provided by the first embodiment with respect to improvement of the operability while reducing the size of the grip 111.

Further, since the retainer member 806 can take the first position and the second position, it is possible to prevent the plug portions of the panel cables (703 and 723) different in the length of the grasping portions (722 and 725) from being pulled off from the socket portion 805.

Note that although each cable described in the second and third embodiments is a panel cable for connecting between the image capturing apparatus body 104 and the panel unit, this is not limitative, but it can be a cable for connecting between the image capturing apparatus body 104 and a device other than the display device.

Note that in the second and third embodiments, the example of application of the structure for retaining the panel cable to the panel unit has been described. However, this is not limitative, and the same cable retaining structure can be applied to the image capturing apparatus body 104.

Note that the present invention can also be applied to an image capturing apparatus formed by integrating the image capturing apparatus body 104 and the lens.

Note that in the above-described embodiments, an expression including “substantially” is not intended to exclude “completely”. For example, expressions of “substantially parallel”, “substantially perpendicular”, “substantially orthogonal”, “substantially the same”, “substantially rectangular shape”, and “substantially rectangular parallelepiped shape” are intended to include “completely parallel”, “completely perpendicular”, “completely orthogonal”, “completely the same state” “completely rectangular shape”, and “completely rectangular parallelepiped shape”, respectively.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-026566 filed Feb. 26, 2024, which is hereby incorporated by reference herein in its entirety.

What is claimed is:

1. An image capturing apparatus comprising:
an image capturing apparatus body; and
a grip rotatably attached to a side surface of the image capturing apparatus body, wherein the grip includes:
a grasping portion for being grasped by a user;
a first, a second, and a third operation elements for being operated by the user;
a first exterior that covers the first operation element at least from the image capturing apparatus body; and
a second exterior that covers the third operation element at least from the image capturing apparatus body,
wherein out of rotational positions of the grip, when the grip is in a first rotational position in which the first operation element and the second operation element are positioned upward of the grasping portion, the third operation element is positioned between the first operation element and the second operation element at a location upward of a line segment connecting between the first operation element and the second operation element, and at the same time, the second exterior is more remote from the image capturing apparatus body than the first exterior.

2. The image capturing apparatus according to claim 1, wherein in the image capturing apparatus body, an operation member for operating the image capturing apparatus body is disposed at a location opposed to the second exterior when the grip is in the first rotational position.

3. The image capturing apparatus according to claim 1, wherein the first, second, third operation elements are any of a push-type key, a direction input key, a slide key, a dial key, and a toggle key.

4. The image capturing apparatus according to claim 1, wherein the first and third operation elements are each a push-type key,
wherein the second operation element is a direction input key, and
wherein a distance between respective centers of the first operation element and the third operation element is shorter than both of a distance between respective centers of the first operation element and the second operation element and a distance between respective centers of the second operation element and the third operation element.

5. The image capturing apparatus according to claim 1, wherein the line segment is substantially parallel to a rotational axis of the grip for the image capturing apparatus body.

6. The image capturing apparatus according to claim 2, wherein the operation member is a member that prevents the cable from being pulled off from the image capturing apparatus body, when a cable for connecting between the image capturing apparatus body and a display device is inserted into the image capturing apparatus body.

7. The image capturing apparatus according to claim 1, wherein the grip is in a second rotational position different from the first rotational position, an air exhaust port provided in the image capturing apparatus body and the first exterior do not overlap each other as viewed from an axial direction of a rotational axis of the grip for the image capturing apparatus body.

8. The image capturing apparatus according to claim 1, wherein the side surface of the image capturing apparatus body is provided with an air exhaust port for exhausting air warmed inside the image capturing apparatus body, and
wherein the air exhaust port is located in the side surface at an end opposite to an object side in a direction of an optical axis and at the same time upward of the optical axis, and opens in the side surface in a substantially perpendicular direction.

9. The image capturing apparatus according to claim 8, wherein the air exhaust port is disposed on a side opposite to an object in the optical axis direction and at the same time upward, with respect to an attaching portion of the image capturing apparatus body where the grip is attached.

10. The image capturing apparatus according to claim 9, wherein compared with the air exhaust port, the attaching portion more protrudes outward of the image capturing apparatus body in a direction perpendicular to the side surface.

11. The image capturing apparatus according to claim 8, wherein an air inlet port is disposed more toward the object side in the optical axis direction than the air exhaust port.

12. The image capturing apparatus according to claim 1, wherein the image capturing apparatus body includes a first socket portion into which a plug of a cable for connecting another device can be removably inserted, and a first retainer member,
wherein the cable has a protruding portion,
wherein the first retainer member has a first engaging portion, and is at the same time rotatable about a first axis substantially parallel to a direction of insertion and removal of the plug into and from the first socket portion, and
wherein when the plug is inserted into the first socket portion, the first engaging portion is engaged with the protruding portion, whereby a retaining function of the first retainer member for retaining the plug is achieved.

13. The image capturing apparatus according to claim 12, wherein an outer shape of the image capturing apparatus body has a substantially rectangular shape as viewed from an object side, and
wherein the first socket portion and the first retainer member are disposed in one corner of the rectangular shape.

14. The image capturing apparatus according to claim 12, wherein the direction of insertion and removal of the plug is substantially parallel to the optical axis.

15. The image capturing apparatus according to claim 12, wherein a display device is communicably connected to the image capturing apparatus body by the cable.

16. The image capturing apparatus according to claim 12, including a display device communicably connected to the image capturing apparatus body by the cable,
wherein the display device includes a second socket portion into which a plug of the cable can be removably inserted, and a second retainer member,
wherein the second retainer member includes a second engagement portion, and at the same time, is rotatable about a second axis substantially parallel to a direction of insertion and removal of the plug to and from the second socket portion, and
wherein when the plug is inserted into the second socket portion, the second engaging portion is engaged with the protruding portion, whereby a retaining function of the second retainer member for retaining the plug is achieved.

17. The image capturing apparatus according to claim 16, wherein the second socket is provided in a rear surface of the display device, and
wherein the direction of insertion and removal of the plug to and from the second socket portion is substantially parallel to the rear surface of the display device.

18. The image capturing apparatus according to claim 12, wherein the cable includes two grasping portions, and a flexible member to which the second retainer is connected, and
wherein the protruding portion is disposed at each of opposite ends of the flexible member.

19. The image capturing apparatus according to claim 12, wherein the protruding portion is provided such that the protruding portion protrudes substantially perpendicular to the direction of insertion and removal of the plug.

20. The image capturing apparatus according to claim 12, wherein the image capturing apparatus body is provided with a recess shaped portion for avoiding the protruding portion when the plug is inserted into the first socket portion, and
wherein the recess shaped portion has a shorter length in the direction of insertion and removal of the plug than a length of engagement between the plug and the first socket portion.

21. The image capturing apparatus according to claim 20, wherein the cable includes a grasping portion, and
wherein the protruding portion is disposed on each of opposite side surfaces of the grasping portion in a direction perpendicular to the direction of insertion and removal of the plug.

22. The image capturing apparatus according to claim 12, wherein the cable includes a grasping portion, and
wherein the image capturing apparatus body is provided with a protruding shape portion brought into contact with the grasping portion when the plug is inserted into the first socket portion.

23. The image capturing apparatus according to claim 12, wherein the image capturing apparatus body is provided with a cover portion engageable with the first socket portion, and
wherein the first retainer member is fixed to the image capturing apparatus body in a state in which the cover portion is engaged with the first socket portion, whereby movement of the cover portion is restricted.

24. The image capturing apparatus according to claim 16, wherein the display device is provided with a recess shaped portion for avoiding the protruding portion when the plug is inserted into the second socket portion, and
wherein the recess shaped portion has a longer length in the direction of insertion and removal of the plug than a length of engagement between the plug and the second socket portion.

25. The image capturing apparatus according to claim 12, wherein the cable includes a grasping portion, and
wherein the display device is provided with a protruding shape portion brought into contact with the grasping portion when the plug is inserted into the second socket portion.

26. The image capturing apparatus according to claim 1, wherein the image capturing apparatus body includes a socket portion into which a plug of the cable for connecting another device can be removably inserted, a retainer member, and a fixing member
wherein the retainer member has an engaging portion,
wherein the retainer member is slidable in the direction of insertion and removal of the plug between the first position and a second position more remote from the socket portion than the first position, and at the same time, is rotatable to a third position in which the engaging portion retreats from between the first position and the second position,
wherein the retainer member is rotated to the third position, whereby the plug can be inserted into and removed from the socket portion,
wherein when the plug is inserted into the socket portion, the engaging portion is engaged with a cable grasping portion which the cable includes, at the first position or at the second position, whereby a retaining function of retaining the plug by the retainer member is achieved, and
wherein the retainer member is fixed to the image capturing apparatus body by the fixing member, whereby sliding movement of the retainer member is restricted.

27. The image capturing apparatus according to claim 26, wherein the fixing member restricts the sliding movement of the retainer member, by urging part of the retainer member toward the image capturing apparatus body.

28. The image capturing apparatus according to claim 27, wherein the fixing member includes a screw member, and the retainer member is fixed to the image capturing apparatus body by screwing the screw member.

29. The image capturing apparatus according to claim 26, wherein the retainer member rotates about a rotational axis substantially parallel to a sliding direction, whereby the retainer member is rotatable to the third position.

30. The image capturing apparatus according to claim 26, wherein the retainer member rotates about a rotational axis substantially orthogonal to a sliding direction, whereby the retainer member is rotatable to the third position.

31. The image capturing apparatus according to claim 1, further comprising a display device communicably connected to the image capturing apparatus body by a cable, and
wherein the display device includes a socket portion into which a plug of the cable can be removably inserted, a retainer member, and a fixing member,
wherein the retainer member has an engaging portion,
wherein the retainer member is slidable in the direction of insertion and removal of the plug between the first position and a second position more remote from the socket portion than the first position, and at the same time, is a rotatable to a third position in which the engaging portion retreats from between the first position and the second position,
wherein the retainer member is rotated to the third position, whereby the plug can be inserted into and removed from the socket portion,
wherein when the plug is inserted into the socket portion, the engaging portion is engaged with a cable grasping portion which the cable includes, at the first position or at the second position, whereby a retaining function of retaining the plug by the retainer member is achieved, and
wherein the retainer member is fixed to the image capturing apparatus body by the fixing member, whereby sliding movement of the retainer member is restricted.

32. The image capturing apparatus according to claim 31, wherein the fixing member restricts the sliding movement of the retainer member, by urging part of the retainer member toward the image capturing apparatus body.

33. The image capturing apparatus according to claim 32, wherein the fixing member includes a screw member, and the retainer member is fixed to a body of the display device by screwing the screw member.

34. The image capturing apparatus according to claim 31, wherein the retainer member rotates about a rotational axis substantially parallel to a sliding direction, whereby the retainer member is rotatable to the third position.

35. The image capturing apparatus according to claim 31, wherein the retainer member rotates about a rotational axis substantially orthogonal to a sliding direction, whereby the retainer member is rotatable to the third position.
